(19) United States
(12) Patent Application Publication
(10) Pub. No.: US 2025/0386878 A1
(43) Pub. Date: Dec. 25, 2025

(54) AEROSOL DELIVERY DEVICE AND SYSTEM

(71) Applicant: Imperial Tobacco Limited, Bristol (GB)

(72) Inventors: Daniel Harden, San Jose, CA (US); Cole DERBY, San Jose, CA (US); Akifusa NAKAZAWA, San Jose, CA (US); Cheng-Fu HSIEH, San Jose, CA (US); David THOMAS, Bristol (GB); Oliver TALBOT, Bristol (GB); Tom SUDLOW, Bristol (GB); Jonathan MARCHBANK, Bristol (GB)

(21) Appl. No.: 19/295,197

(22) Filed: Aug. 8, 2025

Related U.S. Application Data
(63) Continuation of application No. 17/733,666, filed on Apr. 29, 2022.
Application No. 17/733,666 is a continuation of application No. PCT/EP20/81395, filed on Nov. 6, 2020.
(60) Provisional application No. 62/932,830, filed on Nov. 8, 2019.
(60) Provisional application No. 62/932,836, filed on Nov. 8, 2019.
(60) Provisional application No. 62/932,841, filed on Nov. 8, 2019.
(60) Provisional application No. 62/932,857, filed on Nov. 8, 2019.
(60) Provisional application No. 62/932,878, filed on Nov. 8, 2019.
(60) Provisional application No. 62/932,882, filed on Nov. 8, 2019.
(60) Provisional application No. 62/932,891, filed on Nov. 8, 2019.
(60) Provisional application No. 62/932,796, filed on Nov. 8, 2019.

(30) Foreign Application Priority Data
Dec. 20, 2019 (EP) 19218835.7
Dec. 20, 2019 (EP) 19218873.8
Dec. 20, 2019 (EP) 19218885.2
Dec. 20, 2019 (EP) 19218903.3
Dec. 20, 2019 (EP) 19218917.3
Dec. 20, 2019 (EP) 19218930.6
Dec. 20, 2019 (EP) 19218940.5
Dec. 20, 2019 (EP) 19219032.0

(51) Int. Cl. A24F 40/95; A24F 40/46

(52) U.S. Cl. CPC A24F 40/95; A24F 40/46

(57) ABSTRACT

The present disclosure relates to an aerosol delivery device and system, e.g., a smoking substitute device and system. In particular an aerosol delivery device, comprising: a source of power, for providing power to a heater; a first charging connection, for charging the source of power, located at a first end of the aerosol delivery device; and a second charging connection, for charging the source of power.

### CROSS-REFERENCE TO RELATED APPLICATIONS/INCORPORATION BY REFERENCE STATEMENT

This application is continuation of the U.S. patent application identified by Ser. No. 17/733,666, filed Apr. 29, 2022 which claims benefit to the international application no. PCT/EP2020/081395 filed on Nov. 6, 2020, which claims priority to U.S. Provisional No. 62/932,891 filed on Nov. 8, 2019, U.S. Provisional No. 62/932,857 filed on Nov. 8, 2019, U.S. Provisional No. 62/932,841 filed on Nov. 8, 2019, U.S. Provisional No. 62/932,796 filed on Nov. 8, 2019, U.S. Provisional No. 62/932,836 filed on Nov. 8, 2019, U.S. Provisional No. 62/932,830 filed on Nov. 8, 2019, U.S. Provisional No. 62/932,882 filed on Nov. 8, 2019, U.S. Provisional No. 62/932,878 filed on Nov. 8, 2019, EP 19218940.5 filed on Dec. 20, 2019, EP 19218930.6 filed on Dec. 20, 2019, EP 19218917.3 filed on Dec. 20, 2019, EP 19219032.0 filed on Dec. 20, 2019, EP 19218885.2 filed on Dec. 20, 2019, EP 19218873.8 filed on Dec. 20, 2019, and EP 19218835.7 filed on Dec. 20, 2019. The entire contents of each of the above-referenced applications are hereby incorporated herein by reference in their entirety.

### TECHNICAL FIELD

The present disclosure relates to an aerosol delivery device and an aerosol delivery system such as a smoking substitute device/system.

### BACKGROUND

The smoking of tobacco is generally considered to expose a smoker to potentially harmful substances. It is generally thought that a significant amount of the potentially harmful substances are generated through the heat caused by the burning and/or combustion of the tobacco and the constituents of the burnt tobacco in the tobacco smoke itself.

Combustion of organic material such as tobacco is known to produce tar and other potentially harmful by-products. There have been proposed various smoking substitute systems in order to avoid the smoking of tobacco.

Such smoking substitute systems can form part of nicotine replacement therapies aimed at people who wish to stop smoking and overcome a dependence on nicotine.

Smoking substitute systems, which may also be known as electronic nicotine delivery systems, may comprise electronic systems that permit a user to simulate the act of smoking by producing an aerosol, also referred to as a “vapor”, which is drawn into the lungs through the mouth (inhaled) and then exhaled. The inhaled aerosol typically bears nicotine and/or flavorings without, or with fewer of, the odor and health risks associated with traditional smoking.

In general, smoking substitute systems are intended to provide a substitute for the rituals of smoking, whilst providing the user with a similar experience and satisfaction to those experienced with traditional smoking and tobacco products.

The popularity and use of smoking substitute systems has grown rapidly in the past few years. Although originally marketed as an aid to assist habitual smokers wishing to quit tobacco smoking, consumers are increasingly viewing smoking substitute systems as desirable lifestyle accessories. Some smoking substitute systems are designed to resemble a traditional cigarette and are cylindrical in form with a mouthpiece at one end. Other smoking substitute systems do not generally resemble a cigarette (for example, the smoking substitute device may have a generally box-like form).

There are a number of different categories of smoking substitute systems, each utilizing a different smoking substitute approach. A smoking substitute approach corresponds to the manner in which the substitute system operates for a user.

One approach for a smoking substitute system is the so-called “vaping” approach, in which a vaporizable liquid, typically referred to (and referred to herein) as “e-liquid”, is heated by a heater to produce an aerosol vapor which is inhaled by a user. An e-liquid typically includes a base liquid as well as nicotine and/or flavorings. The resulting vapor therefore typically contains nicotine and/or flavorings. The base liquid may include propylene glycol and/or vegetable glycerin.

A typical vaping smoking substitute system includes a mouthpiece, a power source (typically a battery), a tank or liquid reservoir for containing e-liquid, as well as a heater. In use, electrical energy is supplied from the power source to the heater, which heats the e-liquid to produce an aerosol (or “vapor”) which is inhaled by a user through the mouthpiece.

Vaping smoking substitute systems can be configured in a variety of ways. For example, there are “closed system” vaping smoking substitute systems which typically have a heater and a sealed tank which is pre-filled with e-liquid and is not intended to be refilled by an end user. One subset of closed system vaping smoking substitute systems include a device which includes the power source, wherein the device is configured to be physically and electrically coupled to a component including the tank and the heater. In this way, when the tank of a component has been emptied, the device can be reused by connecting it to a new component. Another subset of closed system vaping smoking substitute systems are completely disposable, and intended for one-use only.

There are also “open system” vaping smoking substitute systems which typically have a tank that is configured to be refilled by a user, so the system can be used multiple times.

An example vaping smoking substitute system is the myblu™ e-cigarette. The myblu™ e cigarette is a closed system which includes a device and a consumable component. The device and consumable component are physically and electrically coupled together by pushing the consumable component into the device. The device includes a rechargeable battery. The consumable component includes a mouthpiece, a sealed tank which contains e-liquid, as well as a vaporizer, which for this system is a heating filament coiled around a portion of a wick which is partially immersed in the e-liquid. The system is activated when a microprocessor on board the device detects a user inhaling through the mouthpiece. When the system is activated, electrical energy is supplied from the power source to the vaporizer, which heats e-liquid from the tank to produce a vapor which is inhaled by a user through the mouthpiece.

Another example vaping smoking substitute system is the blu PRO™ e-cigarette. The blu PRO™ e cigarette is an open system which includes a device, a (refillable) tank, and a mouthpiece. The device and tank are physically and electrically coupled together by screwing one to the other. The mouthpiece and refillable tank are physically coupled together by screwing one into the other, and detaching the mouthpiece from the refillable tank allows the tank to be refilled with e-liquid. The system is activated by a button on the device. When the system is activated, electrical energy is supplied from the power source to a vaporizer, which heats e-liquid from the tank to produce a vapor which is inhaled by a user through the mouthpiece.

An alternative to the “vaping” approach is the so-called Heated Tobacco (“HT”) approach in which tobacco (rather than an e-liquid) is heated or warmed to release vapor. HT is also known as “heat not burn” (“HNB”). The tobacco may be leaf tobacco or reconstituted tobacco. In the HT approach the intention is that the tobacco is heated but not burned, i.e., the tobacco does not undergo combustion.

The heating, as opposed to burning, of the tobacco material is believed to cause fewer, or smaller quantities, of the more harmful compounds ordinarily produced during smoking. Consequently, the HT approach may reduce the odour and/or health risks that can arise through the burning, combustion and pyrolytic degradation of tobacco.

A typical HT smoking substitute system may include a device and a consumable component. The consumable component may include the tobacco material. The device and consumable component may be configured to be physically coupled together. In use, heat may be imparted to the tobacco material by a heating element of the device, wherein airflow through the tobacco material causes components in the tobacco material to be released as vapor. A vapor may also be formed from a carrier in the tobacco material (this carrier may for example include propylene glycol and/or vegetable glycerine) and additionally volatile compounds released from the tobacco. The released vapor may be entrained in the airflow drawn through the tobacco.

As the vapor passes through the consumable component (entrained in the airflow) from the location of vaporization to an outlet of the component (e.g., a mouthpiece), the vapor cools and condenses to form an aerosol for inhalation by the user. The aerosol may contain nicotine and/or flavor compounds.

Existing aerosol delivery devices offer only binary feedback to a user. For example, an indicator LED or other source of light may either be illuminated or extinguished based on whether the aerosol delivery device is being used. There exists a need to provide more complete feedback to the user.

Potential users of e-smoking devices (e.g., tobacco smokers) have grown accustomed to the ergonomic feel, sensations, and overall appearance of conventional tobacco-burning products or smoking devices, such as cigarettes or cigars.

To illustrate one such example; when a conventional cigarette or cigar is lit at one end, and particularly after it has been smoked for a period of time, glowing embers (i.e., typically located at the lit end) are known to progressively “burn down” towards the opposite end (i.e., towards the filter tip) of that cigarette or cigar. It is also known that once these glowing embers have visibly reached (or nearly reached) the opposite end of the cigarette or cigar, at this point the user is able to determine the that the cigarette or cigar has fully (or almost fully) burnt out. From this, the users are then able to determine that the conventional cigarette or cigar in question is nearing the end of its use. In this way, conventional cigarettes and cigars have long provided a visual indication to the users of an approximate time scale of available usage time (i.e., smoking time) left, sometimes referred to in the art as a “temporal feel”.

For these reasons at least, it is a known problem in the art that many known e-smoking devices (e.g., e-cigarettes) lack the above-described temporal feel of conventional cigarettes or cigars. This has led to a number of disadvantages associated with known e-smoking devices currently on the market. This is problematic, as many potential users (e.g., smokers of conventional cigarettes or cigars), that may be considering using, or switching to, e-cigarettes, are concerned about how they would keep track of their usage, and/or visually determine a usage time, without the temporal feel that they may have grown very accustomed to. As such, many potential users may subsequently be discouraged from using (or switching to) e-cigarettes as a result of these concerns.

Some smoking substitute devices include a user interface (e.g., LED) for conveying information about the device to a user (e.g., a power status of the device). However, continued activation/operation of the user interface can result in unnecessary power usage of the device (which can in turn result in faster depletion of the battery of the device).

As a user uses the device, the power source loses charge. As the power source approaches a 0% charge level, an operating system of the device may shut down. The device must therefore be appropriately re-started.

The present inventor(s) have observed that most smoking substitute devices currently on the market are configured to operate in isolation of other devices, which limits the functions the smoking substitute devices can perform.

The primary purpose of aerosol delivery devices (e.g., smoking substitute devices) outlined above is to reduce the amount which a user smokes, by providing an alternative to smoking. In order to aid a user in ceasing smoking completely, it is beneficial to provide other activities which a user can perform in order to reduce the amount of time spent using a smoking substitute device.

Accordingly, there is a need for an improved aerosol delivery device/system which addresses at least some of the problems of the known devices and systems.

### SUMMARY

According to a first aspect, there is provided an aerosol delivery device (e.g., a smoking substitute device) comprising:
a source of power, for providing power to a heater;
a first charging connection, for charging the source of power, located at one end of the aerosol delivery device; and
a second charging connection, for charging the source of power.

Such an aerosol delivery device is more easily charged, for example by coupling with a dock or carrying case.

Optional features will now be set out. These are applicable singly or in any combination with any aspect.

The device comprises the source of power which may be a battery. The source of power may be a capacitor. The first charging connection is separate from the second charging connection.

The first charging connection may be a USB connector.

The second charging connection may protrude from a housing of the aerosol delivery device containing the source of power.

The second charging connection may be resiliently biased away from the aerosol delivery device. This can help ensure a good connection.

The second charging connection may comprise a first electrical contact and a second electrical contact. The first and electrical contact and the second electrical contact may be formed of a gold-plated metal.

The second charging connection may be located on one or more lateral sides of the aerosol delivery device. The first electrical contact of the second charging connection may be located on a first lateral side of the aerosol delivery device and the second electrical contact of the second charging connection may be located on a second lateral side of the aerosol delivery device. The second lateral side may be opposite the first lateral side. The first electrical contact and the second electrical contact of the second charging connection may be on a same lateral side of the aerosol delivery device. The first electrical contact and second electrical contact may be located in a row extending along a length of the aerosol delivery device away from the first charging connection. The first electrical contact and second electrical contact may be located in a row extending along a width of the aerosol delivery device. The second charging connection may be nearer the end of the aerosol delivery device containing the first charging connection than an opposite end of the aerosol delivery device.

The aerosol delivery device may further comprise a component adaptor located at a second end of the aerosol delivery device, the second end being opposite the first end.

The second charging connection may be located at the same end of the aerosol delivery device as the first charging connection. The first electrical contact and second electrical contact may be located on opposing sides of the first charging connection. The first charging connection and the second charging connection may be located on a same surface of the aerosol delivery device. For example, the aerosol delivery device may have two end surfaces. The first charging connection and second charging connection may be located on a same end surface of the two end surfaces.

According to a second aspect, there is provided an aerosol delivery device (e.g., a smoking substitute device) comprising:
an inhalation sensor, configured to detect a user inhaling through a mouthpiece of the aerosol delivery device;
a visual feedback element, configured to provide visual feedback to the user; and
a controller, connected to the inhalation sensor and visual feedback element, and configured to gradually change the intensity of the visual feedback element, when the inhalation sensor detects a user inhalation, over a duration of the user inhalation.

Such an aerosol delivery device provides enhanced feedback to a user, by appearing to breathe with the user as they inhale through the mouthpiece.

The controller may be configured to increase the intensity of the visual feedback element in a gradual manner, through a plurality of non-zero intensities. The visual feedback element may be a light emitting diode.

The change of the intensity of the visual feedback element may be based on an intensity and/or duration profile of the inhalation as detected by the inhalation sensor. The change in the intensity of the visual feedback element may be proportional to the intensity and/or duration profile of the inhalation as detected by the inhalation sensor. For example, the intensity of the visual feedback element may increase as the duration of the inhalation increases, and thereby simulate the end of a conventional cigarette. Further, the intensity of the visual feedback may decrease when the intensity and/or flow rate of the inhalation decreases as detected by the inhalation sensor.

The change of the intensity of the visual feedback element may follow a predefined intensity profile. For example, the intensity of the visual feedback element may increase in a linear manner after the controller detects a user inhalation.

The controller may be further configured to terminate visual feedback from the visual feedback element when it detects via the inhalation sensor that inhalation has ceased. The termination of visual feedback may be a step change, that is from the present intensity level directly to zero intensity, or a gradual change to zero intensity. The rate at which the intensity changes to zero may be faster than the rate at which it changed during the user inhalation.

The controller may be further configured to detect a charge level of a battery in the aerosol delivery device, and to vary a parameter of the visual feedback element based on the detected charge level. The controller may be configured to vary a color of the visual feedback element based on the detected charge level being below a predetermined threshold charge level. For example, when the charge level is above the predetermined threshold charge level, the visual feedback element may illuminate with an amber or orange light. Whereas when the charge level is below the predetermined threshold level, the visual feedback element may illuminate with a red light. The predetermined charge level may be around 20%.

The visual feedback element may comprise: an illumination region of a device body of the aerosol delivery device; and a source of light, contained within the device body, the illumination region being configured such that light provided by a source of light passes through the illumination region of the device body; and the controller may be configured to gradually change the intensity of the source of light. The source of light may be an array of light emitting diodes. The illumination region of the device body may be made from a diffusing material, such that the light passing through the illumination region from the source of light is diffused. The device body may include a shell having a first area with a first thickness, and a second area with a second thickness, the first area including the illumination region and the first thickness being thinner than the second thickness. The increase in intensity may cause an area of the illumination region which is illuminated to increase.

According to a third aspect there is an aerosol delivery device (e.g., a smoking substitute device) for use with a consumable component containing an aerosol precursor (e.g., an e-liquid): the aerosol delivery device comprising:
a controller;
an input means;
a visual feedback element;
wherein:
the input means is configured to detect a trigger input from a user, and to output a trigger signal to the controller;
in response to receiving the trigger signal, the controller is configured to initiate a preselected mode of operation, associated with a total available usage;
when the device is operating in the preselected mode, the visual feedback element is configured to indicate a remaining available usage of the device to the user.

An associated advantage of this aspect is that the visual feedback element is able to indicate a remaining available usage of the aerosol delivery device to the user. This allows the users to visually keep track of their usage, and/or visually determine a usage time in a way they may be already accustomed to when using conventional tobacco-burning products. As such, many potential users may feel more comfortable using (or switching to) the device from conventional tobacco-burning products. Furthermore, the device also provides an easy way for the user to determine the remaining available usage in a readily accessible way (i.e., by a visual feedback), which is further advantageous over known e-cigarette (or “vaping”) devices.

In other words, the device advantageously provides a desired “temporal feel” for the user, typically only associated with conventional tobacco-burning products. In this way, the user of the device is advantageously provided with an e-smoking experience which more closely mimics the behavior of a conventional cigarette or cigar. As a result, this may further advantageously make the user more comfortable, or at ease with, with using an e-cigarette device.

The visual feedback element may comprise at least one light source.

To illustrate, a user may be able to provide a trigger input to initiate a preselected mode of operation, where one such mode may be a “burn down” mode, whereby the device provides a visual feedback in the form of a light source, that may mimic the behavior of a conventionally lit (i.e., burning) cigarette or cigar. In other words, the device may be configured to receive a trigger input in order to initiate a smoking session, in which the devices operate in a “burn down” mode, in order to indicate to a user an amount of available usage remaining. One advantage is that the visual feedback to the user can been seen in dark or low lit areas, or in areas with low ambient light. Another associated advantage is that the light source is able to mimic the burning or glowing embers associated with conventional tobacco-burning products. In this way, the user of the device is advantageously provided with an e-smoking experience which more closely mimics the behavior of a conventional cigarette or cigar. Again, this may further advantageously make the user more comfortable, or at ease with, with using an e-cigarette device.

The total available usage of the device may be defined in terms of a predetermined total number of puffs, or a predetermined total amount of smoking time.

Preferably, a predetermined total number of puffs, or a predetermined total amount of smoking time may refer to a fixed (e.g., user pre-set) value or amount, and therefore may not be dependent on other aspect/component of the device, such the amount of battery, power source, or power source capacity available, etc. For example, the user may be able to configure the device to provide a predetermined total number of puffs available for inhalation by the user, or a predetermined total amount of smoking time available to the user. This may be defined by the user via an application (or “app”) installed on a user's personal device (e.g., a smartphone) which may be in wireless or wired communication with the device. For example, the application may include a graphical user interface which allows the user to input or select the total number of puffs available for inhalation by that user, and/or the total amount of smoking time available to that user.

This advantageously allows the user to better customize the device's e-smoking experience, particularly if the user is accustomed to smoking conventional cigarettes which typically may a predetermined (e.g., a finite number) of inhalation puffs in them, or have a predetermined smoking time associated with them. In this way the user of the device is further provided with an e-smoking experience which is customizable, and therefore better mimics the behavior of conventional cigarettes that may be familiar to that user. Again, this may further advantageously make the user more comfortable, or at ease with, with using an e-cigarette device.

In some embodiments, different user inputs may correspond to differently-defined predetermined numbers of puffs or smoking times. Specifically, in response to a first user input, the input means may be configured to output a first trigger signal to the controller, which causes the device to initiate a first preselected mode of operation, and in response to a second user input, the input means may be configured to output a second trigger signal to the controller, which causes the device to initiate a second preselected mode of operation, wherein the predetermined total available usage associated with the first preselected mode of operation is different from the predetermined available usage associated with the second preselected mode of operation. More generally, the input means may be configured to receive any of a plurality of user inputs, and to generate one of a plurality of trigger signals, corresponding to that user input, and in response to the received trigger signal, the controller may be configured to cause the device to initiate a corresponding respective preselected mode of operation. In this way, the user can change the characteristics of the smoking session which they initiate by varying the input. For example, the user may be able to choose between a “short” and a “long” smoking session, depending on what they desire at the time. The aerosol delivery device is thus able to provide a user with more flexibility, in this respect, than a conventional cigarette. As above, each of the preselected modes of input may be configurable by a user.

Accordingly, the input means may be configured to detect a first or second trigger input from a user, and to output a first or second trigger signal to the controller. In response to receiving the first or second trigger signal, the controller is configured to initiate a first or second preselected mode of operation, each of the first and second preselected modes of operation being associated with a respective total available usage defined in terms of a predetermined total number of puffs, or a predetermined total amount of smoking time. The predetermined total available usage associated with the first preselected mode of operation is different from the predetermined available usage associated with the second preselected mode of operation. When the device is operating in the first or second preselected mode, the visual feedback element is configured to indicate a remaining available usage of the device to the user.

The input means may be in the form of a movement sensor, configured to detect some kind of motion of the device. Preferably, the movement sensor includes an accelerometer which is configured to detect an acceleration, a force, or an impulse applied to the device. In preferred embodiments, the accelerometer is configured to detect a trigger input in the form of one or more taps on the device by a user. Referring to the previous section, different numbers of taps may correspond respectively to different preselected modes of operation, and thus, to different predetermined total available usages.

Alternatively, the accelerometer may be configured to detect movement of the device when the device is moved in any way, and typically when the device is either tapped, shaken, touched, or knocked by the user. However, in preferred embodiments, the trigger input includes a complex pattern of movements which are unlikely to be effected unintentionally, e.g., if the device is located the pocket of a walking user. The trigger input may have an associated frequency or time period (i.e., the rate of, or interval between successive taps, knocks or shakes) which does not correspond to an average human walking pace. For example, a user may be able to trigger an input to activate the previously discussed “burn down” mode by tapping the device twice. It is well known in the art, that users of conventional cigarettes (at least) are often required to “tamp” or “pack” the cigarette in order to physically condense the tobacco contained within the (typically) paper cylindrical body of that cigarette. As such, many smokers are accustomed to “tamping” or “packing” each cigarette in this way before using them (e.g., lighting the tip of the cigarette, often refer to as “lighting up”). This behavior is therefore instinctive to many smokers and often done out of habit.

In this way, by having a trigger input to the device in the form of an accelerometer, the device is able to detect a user motion typically associated with conventional smoking behavior, namely “tamping” or “packing” (e.g., tapping, shaking, knocking, etc.) of conventional cigarettes. The device advantageously responds to a trigger input provided by a user that would otherwise only be associated with conventional cigarettes. In this way, the user of the device may further be provided with an e-smoking experience which more closely mimics the behavior of a conventional cigarette. Again, this may further advantageously make the user more comfortable, or at ease with, with using an e-cigarette device.

The device may comprise a vibrating means, wherein the controller is configured to cause the vibrating means to vibrate in response to receiving the trigger signal, thereby generating audible or haptic feedback.

A user may wish to feel physical responses, such as vibrations, from the device additionally, or alternatively to, receiving a visual feedback from the device. The vibrating means allow the user to additionally feel responses from a device (e.g., in response to receiving a trigger signal). This is particularly advantageous for the user if the device is not directly visible to the user (e.g., if the device is in the user's pocket). The vibrating means may be in the form of a haptic motor for vibrating the device and/or producing an audible noise for the user to hear. Alternatively, or additionally, the vibrating means may be in the form of a buzzer or alarm. Advantageously, the vibrating means may also allow the user to hear responses from the device when the user is located a certain distance away from the proximity of the device, such as in the form of an audible noise. To illustrate, this may be in the form of the device vibrating on a solid surface (e.g., on a bedside table), or the device sounding a buzzer/alarm out loud.

The at least one light source may be configured to display a flashing light signal and/or display a solid light signal to the user for a predetermined time period.

Advantageously, by using solid light signals and/or flashing lights signals, the device may be able to communicate, or visibly convey, different types of alerts, notifications, and/or or messages to the user in a visual way. Furthermore, a flashing light signal may mimic the flickering and/or glowing embers typically associated with conventional tobacco-burning products. This way, the user of the device may further be provided with an e-smoking experience which more closely mimics the behavior of a conventional cigarette. Again, this may further advantageously make the user more comfortable, or at ease with, with using an e-cigarette device.

The device, specifically the device body may include an illumination region, configured to be illuminated by the one or more light sources. For example, the one or more light sources may be located inside the device body, and the illumination region may include a transparent or translucent material located such that the light sources are visible from outside the device.

The illumination region may include light diffusion plastic for diffusing light produced by the at least one light source. An associated advantage may be that the diffusion plastic is able to diffuse light produced by the device in such a way that it creates a visual effect which resembles the gradual light-fade associated with the burning (or burning out) or glowing embers in conventional tobacco-burning products. This is also referred to as a “feathering” effect. In other words, the diffusion plastic may advantageously be able to remove the stark glow of artificial light (e.g., as produced by light emitting diodes, hereafter referred to as LEDs), as are typically produced in known e-cigarette products on the market. In this way, any “hard” to visually “sharp” edges of the produced/emitted light are reduced by the light diffusion plastic of the device. In this way, the user of the device may further be provided with a smoking experience which more closely mimics the behavior of a conventionally lit (i.e., burning) cigarette or cigar. Again, this may further advantageously make the user more comfortable, or at ease with, with using an e-cigarette device. Alternatively, or additionally, the above-described feathering-effect may also be enhanced by varying the radius of curvature the body of the device (also referred to as a “light pipe” or “body radius drop-off”).

In one example, the diffusion plastic is formed from an electrically and thermally insulating material. In this way, the diffusion plastic may function as a protective mask in front of the LEDs in order to avoid hot spots forming on the outer surface of the device's body. This advantageously prevents the user from burning their hands, or simply avoids the device's body becoming too warm, and thereby becoming uncomfortable to hold for long periods of time, for example.

The controller may be configured to vary an amount of the illumination region which is illuminated at a given time, based on the remaining available usage, for example by controlling the one or more light sources. The controller may also be configured to vary a brightness of the one or more light sources, again based on the remaining available usage.

The visual feedback element may include a plurality of light sources (e.g., an array of LEDs, bulbs) arranged along the illumination region. In embodiments in which the illumination region includes a translucent or transparent material, the light sources may be located beneath this material. Alternatively, the light sources may be located on an external surface of the device or device body. Alternatively, or additionally, the at least one light source may be a single light source (e.g., a single bulb, LED).

The illumination region may be formed along a length of the body of the device, and is preferably elongate in shape, and in preferred embodiments may have a length approximately the same as a traditional cigarette. The illumination region may be formed along either the full, or partial, longitudinal length of the device body.

The controller may be configured to control the visual feedback element such that the proportion of the illumination region which is illuminated provides an indication of the remaining available usage. For example, when the illumination region is illuminated along the full longitudinal length of the device, the illumination region may visibly resemble the length of an un-lit (i.e., un-used) conventional cigarette to the user. Similarly, when the illumination region is illuminated along the partial length of the device, the illumination region may instead visibly resemble the length of a lit cigarette (i.e., in use) to the user. In other words, this advantageously allows the illumination region to visibly resemble a conventional cigarette which is progressively “burning down” towards the opposite end (i.e., undergoing the “burn down” mode). In some embodiments, the proportion of the illumination region which is illuminated may correspond to a proportion of the plurality of the light sources which are illuminated at a given time. In other words, the controller may be configured to control the visual feedback element such that the proportion of the plurality of light sources which is illuminated corresponds to the remaining available usage.

In both scenarios, the user of the device is advantageously provided with an e-smoking experience which more closely mimics the behavior of a conventional cigarette. Again, this may further advantageously make the user more comfortable, or at ease with, with using an e-cigarette device.

The at least one light source is configured to display a full brightness level in order to indicate:
a full number of inhalation puffs available,
or a full time duration of each inhalation puff available;
and is further configured to display a partial brightness level in order to indicate:
a partial number of inhalation puffs available,
or a partial time duration of each inhalation puff available;
and is further configured to display a zero-brightness level in order to indicate:
   a zero number of inhalation puffs available,
   or a zero time duration of each inhalation puff available.

In one example, the brightness level of the at least one light source (e.g., an array of LEDs) may be varied from full brightness (i.e., a 100% brightness level), through a partial brightness (e.g., a 50% brightness level), to a zero brightness (i.e., a 0% brightness level). In other words, the device may be able to vary the brightness level being displayed to the user depending on whether there is either a full, partial, or zero number of inhalation puffs available to that user. Similarly, the device may be able to vary the brightness level being displayed to the user in depending on whether there is either a full, partial, or zero time of duration of each inhalation puff available to that user. As the skilled person will appreciate, measured brightness as a percentage may be defined by a continuous spectrum or range, i.e., ranging between a full-brightness (i.e., 100%) and zero-brightness (i.e., 0%). In this way, any brightness percentage value falling between 100% and 0% brightness may be considered a “partial brightness”.

Advantageously, these varying brightness levels of the device can visually indicate two different values (or device parameters) to the user at any one time. Moreover, these varying brightness levels provide the user with a visual indication of any ‘on-the-fly’ changes to these two different values (or device parameters) progressively over time, or during use of the device. This therefore provides the user with an easy-to-read way of monitoring the progress of their e-smoking session at any one time.

The controller may be configured to determine an amount of power remaining in a power supply, and the visual feedback element may be further configured to indicate the remaining amount of power. The controller may be configured to cause the visual feedback element to illuminate the illumination region in a different color, depending on the amount of power remaining.

In an example, the visual feedback element may be further configured to indicate an amount of remaining amount of power left in the power supply of the device to the user by varying the color, brightness, and/or intensity of the light emitted by the at least one light source.

Advantageously this further allows the device to visually indicate a battery power level to the user ‘on-the-fly’. Again, the device therefore provides the user with an easy-to-read method of monitoring the battery power levels available to the device (e.g., via the battery), so that they may be able to time-manage their e-smoking sessions more effectively. To illustrate an example scenario; a user may determine to not spend a lot of time using the device for an e-smoking session it if the power supply is indicated to be low, whereas they may determine to spend more time using the device if the opposite is true (i.e., the power supply is indicated to be ample).

The controller may be configured to compare the determined amount of power remaining in the power supply with a predetermined threshold, and if the amount of power remaining is greater than or equal to the threshold, the controller is configured to cause the visual feedback element to generate the illumination region in a first color, and if the amount of power remaining is less than the threshold, the controller is configured to cause the visual feedback element to generate the illumination region in a second color.

The choice of color generated in the illumination region of the device may advantageously indicate the criticality (or severity) of the current power level to the user. For example, a first color may be amber to indicate to the user that the current power level is at a non-critical level, whereas the second color may be red, indicating to the user that the current power level is at a critically low level.

In a preferred embodiment of the device 102, if the controller determines that the amount of power remaining is greater than or equal to a threshold value of 20% of the total power supply capacity available (i.e., the threshold is >20%), then the controller is configured to cause the visual feedback element (e.g., an array of LEDs) to illuminate the illumination region in amber colored light. In contrast, if the controller determines that the amount of power remaining is less than or equal to a threshold value of 20% of the total power supply capacity available (i.e., the threshold is 20%), then the controller is configured to cause the visual feedback element to illuminate the illumination region in red colored light. As the skilled person will appreciate, the specific threshold value is not limited to being either above or below a 20% value of the total power capacity available, and may instead be any pre-set percentage value of the total power capacity available. As the skilled person will further appreciate, the visual feedback element may be illuminated in any colored light (e.g., white, blue, or green, etc.) and are not limited to the specific colors mentioned or illustrated in this application.

According to a fourth aspect there a method of delivering an aerosol precursor from the aerosol delivery device (as previously described); wherein the method comprises the following steps:
detecting a trigger input from the user,
outputting the trigger signal to the controller;
in response to receiving the trigger signal, causing the device to enter a preselected mode of operation, associated with a predetermined total available usage;
and when the device is operating in the preselected mode, providing a visual feedback element to indicate a remaining available usage of the device to the user.

According to a fifth aspect, there is provided an aerosol delivery device (e.g., a smoking substitute device) comprising:
a movement sensor configured to detect movement of the device and transmit movement signals indicative of movement of the device;
a user feedback element configured to receive feedback signals and provide feedback to a user in response to the feedback signals; and
a controller configured to receive a movement signal from the movement sensor, determine whether a time period since a previous user interaction with the device exceeds a threshold time period, and provide a feedback signal to the user feedback element if the time period exceeds the threshold time period.

Thus, such an arrangement may allow the user feedback element to react suitably to periods where the device is in an idle state during a period of inactivity (i.e., is not being used by the user). During such periods, it may be desirable to minimize activation of the user feedback element in order to reduce power consumption. Thus, the provision of a feedback signal to the user feedback element upon detection of movement of the device (i.e., after a period of inactivity) may mean that the user feedback element is only activated when the user is using the device. This may help to reduce unnecessary power consumption by the device.

The controller may be configured to receive a user interaction signal from a component of the device in order to determine that a user interaction has occurred (i.e., so as to be able to determine the time period since the previous user interaction). That is, the previous user interaction may be determined from a previous user interaction signal received by the controller. In other words, the controller may receive an interaction signal and then subsequently receive the movement signal and determine the time period between the two signals (for comparison with the threshold time period).

The user interaction signal may be indicative of the device being connected to an external power source (for, e.g., recharging a battery of the device) and the interaction signal may be received from a charging connector (for connecting the device to an external power source). In this respect, the time period may be between the connection of the device to the external power source and a subsequent movement of the device.

The user interaction signal may be indicative of an inhalation (i.e., puff) from the device by a user. Thus, the device may comprise an airflow/inhalation (i.e., puff) sensor that detects inhalation and the user interaction signal may be at least partly provided by the airflow sensor. In such embodiments, the time period may thus be between an inhalation and a subsequent movement of the device.

The user interaction may be indicative of movement of the device. In this case, the time period may be determined by the controller based on the time difference between two (i.e., consecutive) signals received from the movement sensor.

In some embodiments, the user interaction signal may be any one of a signal indicative of connection to an external power source, a signal indicative of inhalation and a signal indicative of movement of the device. In other words, in one embodiment, a detection of any one of charging, movement or inhalation can initiate the time period that the controller compares against the threshold time period.

The threshold time period may be stored in a memory of the device (to which the controller is operatively connected). The threshold time period may, for example, be greater than 10 seconds, or, e.g., greater than 30, 60, 120 or 240 seconds.

To determine the time period between the interaction signal and the movement signal, the controller may be configured to initiate a timer upon receipt of the interaction signal. The controller may terminate the timer upon receipt of the movement signal.

Alternatively, the controller may generate a first timestamp (e.g., and store the timestamp in the memory) on receipt of the interaction signal and a second timestamp on receipt of the movement signal (i.e., the difference between the timestamps providing an indication of the time period).

In other embodiments, the controller may initiate a timer on receipt of the interaction signal and, in response to the timer exceeding the threshold time period, may store (i.e., in the memory of the device) an indication that the device has entered an idle state. Upon receipt of a subsequent movement signal, the controller may retrieve the state of the device from the memory and, if the stored state indicates that the device is in an idle state, may accordingly provide a feedback signal to the user feedback element.

The movement sensor may be an accelerometer, for detecting movement of the device. Where, the user interaction is (or comprises) movement of the device, the movement may be any movement of the device, or a specific movement (or motion) of the device by a user. In other words, the user interaction signal may be indicative of a specific movement of the device. In one embodiment, the specific movement may be one or more taps (by a user) on the device. The controller may be configured to determine whether the user interaction signal received from the sensor is indicative of the specific movement (e.g., tapping) of the device and only provide a feedback signal upon determination that the detected movement matches the specific movement. For example, the memory of the device may comprise a database of specific movement signals and, upon receipt of the interaction signal, the controller may interrogate the database in order to determine whether the received interaction signal matches a specific movement signal in the database.

The user feedback element may comprise a haptic feedback generation unit (e.g., an electric motor and a weight mounted eccentrically on a shaft of the electric motor). Thus, the feedback signal may be received from the controller by the haptic feedback generation unit and the haptic feedback generation unit may generate haptic feedback in response to the feedback signal. In this respect, the feedback signal may be representative of a haptic feedback (vibration) pattern. Thus, for example, haptic feedback may be provided upon movement of the device by a user when the device is an idle state, which may indicate to the user that the device is operational and that, e.g., a battery of the device is not fully discharged. This provides a convenient, low-power, way in which to communicate such information to a user. For example, this may mean there is no need to have a display or LED that remains active even when the device is not being used (which would be detrimental to battery life).

The user feedback element may comprise visual feedback element, for example one or more lights (e.g., LEDs) and/or a display screen. Thus, for example, the one or more lights may receive the feedback signal and illuminate accordingly (i.e., in response to user interaction when the device is in an idle state).

The controller may be configured to provide a feedback signal that is indicative of an operating characteristic of the device. The device may comprise a source of power which may be a battery (e.g., a rechargeable battery). The source of power may be a capacitor. The operating characteristic of the device (indicated by the feedback signal) may be a charge level of the battery. In other words, user feedback element may, in response to user interaction when the device is in an idle state, communicate the battery charge level of the battery.

Where the feedback signal is received by a haptic feedback generation unit, this communication may be, for example, by way of a particular haptic feedback (vibration) pattern dependent on the level of charge. Where the feedback signal is received by one or more LEDs of the device, the battery level may be communicated, for example, by the brightness or color of the LEDs, or the number of LEDs that are illuminated (where the device comprises a plurality of LEDs).

In one example, the user feedback element may comprise an LED and the feedback signal provided to the LED may be representative of a charge level of a battery of the device. For example, the controller may control the LED (i.e., via the provision of the feedback signal) so as to illuminate with a particular color and/or brightness depending on the current charge level of the battery of the device.

According to a sixth aspect, there is provided a method of controlling an aerosol delivery device (e.g., a smoking substitute device), the method comprising:
detecting movement of the device;
upon detection of the movement, determining whether a time period since a previous user interaction with the device exceeds a threshold time period; and
providing a feedback signal to a user feedback element of the device for feedback to a user, if the time period exceeds the threshold period.

The method may comprise detecting the previous user interaction. The previous user interaction may be one or more of movement of the device, connection of the device to an external power source and inhalation through the device by a user.

The method may further comprise determining an operating characteristic of the device upon receipt of the movement signal. The operating characteristic may be a battery charge level of a battery of the device. The feedback signal may be indicative of the operating characteristic (e.g., battery charge level) of the device.

According to a seventh aspect, there is provided an aerosol delivery device (e.g., a smoking substitute device) comprising:
a power source having a charge level;
a controller configured to perform a boot sequence when the charge level of the power source is below a predetermined level; and
a feedback unit
wherein the controller is configured to cause the feedback unit to output feedback:
   a) when the boot sequence initiates; and/or
   b) during the boot sequence; and/or
   c) when the boot sequence completes.

Such a device is advantageously able to suitably re-boot and provide feedback to a user that the device is re-booting. By providing output feedback to the user at a particular stage of the boot sequence, the user can be informed of exactly which stage of the boot sequence the controller is performing. By providing an output feedback at any one or all of the stages of the boot sequence, the user can be informed that the boot sequence is advancing through its stages as required.

The controller may be configured to initiate the boot sequence when the power source is connected to an electrical power supply.

The controller is configured to initiate the boot sequence when the power source is below a predetermined charge level. In preferred embodiments, the controller is configured to initiate the boot sequence when the power source is at a zero percent charge level.

The device includes a controller configured to cause the feedback unit to output feedback as it detects the device is performing a boot sequence.

The controller is configured to perform a boot sequence. In particular, the controller may be configured to initiate the boot sequence, carry out the boot sequence and complete the boot sequence.

The feedback unit may include a visual feedback element, for example one or more lights, e.g., an LED or multiple/an array of LEDs. The feedback unit may include a haptic feedback generation unit for providing haptic feedback to the user. The haptic feedback generation unit may comprise a vibration element such as an eccentric rotating mass (ERM) actuator, a linear resonant actuator (LRA) or a piezoelectric actuator.

The feedback unit may include both a visual feedback element and a haptic feedback generation unit.

The controller may be configured to cause the visual feedback element to output feedback (i.e., to illuminate) at any one of the boot sequence stages (i.e., the controller may be configured to cause the visual feedback element to illuminate when the controller initiates the boot sequence and/or during the boot sequence and/or when the controller completes the boot sequence). Preferably, the controller may be configured to cause the visual feedback element to illuminate when the controller initiates the boot sequence and during the boot sequence.

The controller may be configured to cause the visual feedback element to illuminate at a maximum intensity (or 100% of the visual feedback element's intensity capability) when the controller initiates the boot sequence and/or during the boot sequence and/or when the boot sequence completes.

The controller may be configured to cause the visual feedback element to illuminate in a pulsed or flashing operation when the controller initiates the boot sequence and/or during the boot sequence and/or when the boot sequence completes. The visual feedback element may be configured to illuminate in a pulsed or flashing operation at intervals of a predetermined number of seconds, for example at 1 or 2 or 3 or 4 or 5 second intervals.

Preferably, the controller is configured to cause the visual feedback element to illuminate in a pulsed/flashing operation (e.g., at 3 second intervals) when the controller initiates the boot sequence and during the boot sequence. This advantageously allows the user to know that the boot sequence has initiated and that the boot sequence is being carried out.

The controller may be configured to cause the visual feedback element to illuminate with varying (e.g., increasing or decreasing) intensity. For example, the visual feedback element may be configured to illuminate with increasing intensity from 0% to 100% of the visual feedback element's intensity capability. The visual feedback element may be configured to illuminate with increasing intensity (e.g., from 0% to 100% of its intensity capability) during a single pulse.

The controller may be configured to cause the visual feedback element to illuminate (e.g., in a pulsed operation and with increasing intensity of 0-100% at each pulse) during the boot sequence and until completion of the boot sequence.

The controller may be configured to terminate feedback output from the visual feedback element when the controller completes the boot sequence. This advantageously allows the user to know that the boot sequence has completed.

The visual feedback element may be colored (e.g., blue).

The controller may be configured to cause the haptic feedback generation unit to output feedback (e.g., to vibrate) when the boot sequence initiates and/or during the boot sequence and/or when the boot sequence completes.

The controller may be configured to cause the haptic feedback generation unit to vibrate for a predetermined length of time (i.e., a predetermined number of seconds), for example no more than 5 seconds, preferably no more than 2 seconds. The controller may be configured to cause the haptic feedback generation unit to emit a vibration pulse or burst (e.g., a single or multiple vibration pulse(s)).

The controller may be configured to cause the haptic feedback generation unit to emit a vibration pulse when the boot sequence initiates and/or when the boot sequence completes. This advantageously allows the user to know that the boot sequence has initiated and/or that the boot sequence has completed. In particular, this provides a positive physical indication to the user that the boot sequence has initiated and/or completed.

According to an eighth aspect, there is provided a method of controlling an aerosol delivery device, the method including the steps of:
performing a boot sequence
causing a feedback unit to output feedback:
   a) when the boot sequence initiates; and/or
   b) during the boot sequence; and/or
   c) when the boot sequence completes.

The method may include detecting the charge level of a power source of the device.

The method may include providing the feedback unit with a visual feedback element and causing the visual feedback element of the feedback unit to illuminate when the boot sequence initiates, and/or during the boot sequence and/or when the boot sequence completes.

The method may include causing the visual feedback element to illuminate at a maximum intensity (or 100% of the visual feedback element's intensity capability). The method may include causing the visual feedback element to illuminate in a pulsed or flashing operation at intervals of a predetermined number of seconds (for example at 1 or 2 or 3 or 4 or 5 second intervals) when the controller initiates boot sequence and/or during boot sequence and/or when the controller completes boot sequence.

The method may include causing the visual feedback element to illuminate with varying (e.g., increasing or decreasing) intensity. For example, the method may comprise causing the visual feedback element to illuminate with increasing intensity from 0% to 100% of the visual feedback element's intensity capability. The method may comprise causing the visual feedback element to illuminate with increasing intensity (e.g., from 0% to 100% of its intensity capability) during a single pulse.

The method may comprise causing the visual feedback element to illuminate (e.g., in a pulsed operation and with increasing intensity of 0-100% at each pulse) during the boot sequence and until completion of the boot sequence. The method may comprise terminating feedback output from the visual feedback element when the boot sequence completes.

The method may comprise providing the feedback unit with a haptic feedback generation unit and causing the haptic feedback generation unit to output feedback (e.g., to vibrate) when the boot sequence initiates and/or during the boot sequence and/or when the boot sequence completes.

The method may comprise causing the haptic feedback generation unit to vibrate for a predetermined length of time, for example no more than 5 seconds, preferably no more than 2 seconds. The method may comprise causing the haptic feedback generation unit to emit a vibration pulse or burst.

The method may comprise causing the haptic feedback generation unit to vibrate at any stage of the boot sequence. For example, the method may comprise causing the haptic feedback generation unit to vibrate during the boot sequence. Preferably, the method comprises causing the haptic feedback generation unit to emit a vibration pulse when the boot sequence initiates and/or when the boot sequence completes.

The boot sequence may include loading an operating system or a start-up process/service of the device to the memory.

In a ninth aspect there is provided an aerosol delivery device including: a movement sensor; a controller; and a feedback unit, wherein: the movement sensor is configured to generate a movement detection signal in response to detection of movement of the device, the controller is configured to receive the movement detection signal, and to control operation of the device based on the movement detection signal; and the controller is further configured to cause the feedback unit to output feedback based on the movement detection signal.

For clarity, it should be noted that here, the expression “operation of the device” refers broadly to the operation of the device other than control of the feedback unit. For example, this could refer to the aerosol-generating operation of the device or controlling the interaction between the aerosol delivery device and an external device.

In some embodiments, the movement sensor is configured to generate a movement detection signal in response to detection of movement of the device corresponding to a predetermined movement input, the controller (120) is configured to cause the device to perform an action based on the movement detection signal; and the controller (120) is further configured to cause the feedback unit to output feedback corresponding to the predetermined movement input based on the movement detection signal, wherein the controller is configured to cause the device to perform the action only in response to a confirmation input received after the feedback unit has output the feedback corresponding to the received movement input.

In preferred embodiments of the ninth aspect, the feedback unit includes an audible or haptic feedback generation unit, e.g., a vibrating element such as a haptic motor, and is thereby configured to provide either audible or haptic feedback. Alternatively, the feedback unit may comprise a visual feedback element and thus may be configured to provide visual feedback.

“Operation of the device” may encompass a plurality of actions, including but not limited to activating the heater, de-activating the heater, changing a temperature of the heater, pairing with an external device, or causing the device to send data to an external device. The device may be configured to perform a respective action of the plurality of actions in response to the detection of a predetermined movement input, which is detectable by the movement sensor. Accordingly, the controller may be configured to cause the device to perform a first action in response to detection of a first movement input by the movement sensor, and the controller may be configured to cause the device to perform a second action in response to detection of a second movement input by the movement sensor. More broadly, the controller may be configured to cause the device to perform a respective one of a plurality of predetermined actions in response to the detection of a corresponding movement input by the movement sensor. In order to achieve this, the device may include a memory storing a lookup table, the lookup table containing relationships between the movement inputs and the corresponding actions. Then, in response to the detection of a predetermined movement input by the movement sensor, the controller may be configured to search the lookup table for that movement input, and in doing so, identify the corresponding action to be performed by the device.

The predetermined movement inputs may be in the form of one or more taps of the device against a surface (preferably a hard surface), or a user tapping the surface with, e.g., their finger or thumb. These movement inputs are characterized by an impulse or force being applied to the device. So, it is preferred that the movement sensor includes an accelerometer to detect the acceleration cause by the imparted impulse or force. Each respective movement input may be in the form of a pattern of taps, characterized by the number of taps, and the amount of time between successive taps.

While this should be avoided, if there are a large number of predetermined movement inputs, some of those inputs may inevitably be similar to each other. In such cases, after inputting a given input, such as a pattern of taps, a user may be unsure whether they have input the correct sequence. The present aspect allows this issue to be addressed by providing feedback to the user based on the movement detection signal. Specifically, in response to the detection of a predetermined movement input by the movement sensor, in addition to causing the device to perform a corresponding action, the controller may be configured to cause the feedback unit to provide feedback corresponding to the predetermined movement input. Preferably, the corresponding feedback is configured to somehow mimic the predetermined movement input. For example, when the predetermined movement input is in the form of a pattern of taps, the feedback may be in the form of a matching series of sounds, vibrations, or lights. Here, “matching” means that the number of sounds, vibrations or lights is the same as for the pattern of taps, and optionally, the time interval between successive sounds, vibrations, or lights is the same as for the pattern of taps. In some cases, so that the corresponding feedback is shorter in duration, the duration of the sounds, vibrations, or lights, or the time intervals between successive sounds, vibrations or lights may be reduced by a constant factor. This may result in the feedback taking half as long as the initial predetermined movement input.

So, according to such embodiments, a user may enter some instruction in the form of a pattern of taps, and then receive an identical or similar pattern back, e.g., in the form of sounds, vibrations or lights. The user is thus informed whether or not they have put the instruction in correctly. The user may then have the opportunity to confirm their instructions. Specifically, the controller may be configured to cause the device to perform the action corresponding to the movement input detected the movement sensor, only in response to a confirmation input received after the feedback unit has output the feedback corresponding to the received movement input. In some embodiments, the controller may be configured to cause the device to perform the action corresponding to the movement input detected the movement sensor, only in response to a confirmation input received within a predetermined amount of time after the feedback unit has output the feedback corresponding to the received movement input.

Just as a user may be able to confirm that they have input the correct signal, in some embodiments the user may be able to input another input in response to the feedback to indicate that they do not want the device to perform the action corresponding to the feedback, e.g., because they accidentally input the pattern of taps wrongly. Specifically, in response to a stopping input received after the feedback has been output to a user, the controller may be configured not to cause the device to perform the action corresponding to the predetermined movement input. Optionally, the stopping input must be received within a predetermined amount of time after the feedback unit has output the feedback in order for the action not to be performed.

According to a tenth aspect, there is provided an aerosol delivery device comprising a device body, the device body having a controller, and a movement sensor configured to sense movement of the aerosol delivery device; wherein the controller is configured to send an advertising communication to a mobile device when: a component is coupled to the device body; and a predetermined movement of the aerosol delivery device is detected using the movement sensor.

In this way, a user can instruct the aerosol delivery device to attempt to pair (i.e., establish a communication link) with a mobile device by performing simple actions on the aerosol delivery device. A communication link between the aerosol delivery device and a mobile device may provide additional functions which the aerosol delivery device itself cannot perform.

The advertising communication may a wireless advertising communication. The advertising communication may comprise a request to establish a communication link (e.g., a request to pair) with the mobile device.

The controller may be configured to send the advertising communication to the mobile device only when the component is coupled to the device body, and the predetermined movement of the aerosol delivery device is detected using the movement sensor.

In this way, if the user does not couple the component to the device body and does not also perform the predetermined movement of the aerosol delivery device, the controller does not send an advertising communication to the mobile device. Accordingly, a user can decide when, or if, they would like the aerosol delivery device to pair with the mobile device.

The device body may be configured to be physically coupled and/or electrically coupled to the component.

The controller may be configured to send the advertising communication to the mobile device when the component is physically coupled to the device body. Alternatively, or additionally, the controller may be configured to send the advertising communication to the mobile device when the component is electrically coupled to the device body.

The controller may be configured to detect whether the aerosol delivery device is in a disassembled state in which the component is not coupled to the device body, or an assembled state in which the component is coupled to the device body. Accordingly, the controller may be configured to send the advertising communication when the controller detects that the aerosol delivery device is in the assembled state (and thus that the component is coupled to the device body).

The controller may be configured to detect a change in the state of the aerosol delivery device (i.e., a change between the disassembled state and the assembled state). In this way, the controller may be configured to determine when the aerosol delivery device is moved from the disassembled state and the assembled state.

Accordingly, the controller may be configured to send the advertising communication to the mobile device when a change in state of the aerosol delivery device is detected, the change in state being from a disassembled state in which the component is not coupled to the device body, to an assembled state in which the component is coupled to the device body.

Optionally, the controller may be configured to send the advertising communication to the mobile device when the change in state of the aerosol delivery device is detected before the predetermined movement of the aerosol delivery device is detected.

Alternatively, the controller may be configured to send the advertising communication to the mobile device when the change in state of the aerosol delivery device is detected after the predetermined movement of the aerosol delivery device is detected. In other embodiments, the controller may be configured to send the advertising communication to the mobile device when the predetermined movement and the change in state of the aerosol delivery device are detected in either order.

Optionally, the controller may be configured to send the advertising communication to the mobile device when the detection of the change in state of the aerosol delivery device and the detection of the predetermined movement of the aerosol delivery device are within a predetermined period of time.

The predetermined period of time may be 60 seconds or less, 30 seconds or less, 20 seconds or less, or 10 seconds or less, for example.

Preferably, the movement sensor may include at least one accelerometer. Optionally, the movement sensor may include one or more gyroscopes and/or magnetometers.

Optionally, the predetermined movement detected using the movement sensor may include a tap of the aerosol delivery device (e.g., tapping the aerosol delivery device against a surface, such as the user's finger), and preferably includes a sequence of taps of the aerosol delivery device (e.g., a double tap, a triple tap, continuous taps etc.).

For example, the predetermined movement detected using the movement sensor may include a sequence of taps of the aerosol delivery device performed within a predetermined “tap sequence” length of time (e.g., within 5 seconds). For example, the predetermined movement may include 5 taps, wherein the 5 taps are performed within a predetermined “tap sequence” length of time (e.g., within 5 seconds).

In some embodiments, the aerosol delivery device may be configured to provide a first feedback indication to the user when both the predetermined movement is detected and the component is coupled to the device. The first feedback indication may indicate to the user that the aerosol delivery device is searching for a mobile device using the advertising communication.

The aerosol delivery device may be configured to establish a communication link with an application installed on the mobile device. This communication link may pair the aerosol delivery device with the application installed on the mobile device. Communication can be, for example, over a short-range wireless network such as Bluetooth™. Other wireless communication networks may of course be used such as a cellular network (such as 3G or 4G) or a WIFI network.

The aerosol delivery device may further comprise a wireless interface, wherein the aerosol delivery device is configured to communicate wirelessly with the application installed on the mobile device through the communication link via the wireless interface.

The aerosol delivery device may be configured to provide a second feedback indication to the user when a communication link between aerosol delivery device and an application installed on the mobile device is established. This second feedback indication may indicate to the user that the aerosol delivery device is paired with the mobile device.

The first and/or second feedback indications may be visual feedback indications.

In an eleventh aspect, there is provided a system for managing an aerosol delivery device, the system including:
an aerosol delivery device according to the tenth aspect; and
a mobile device,
wherein, upon receipt of the advertising communication from the aerosol delivery device, the application is configured to establish a communication link with the aerosol delivery device.

The communication link may be a wireless communication link, such as over a Bluetooth™ network, for example.

In some embodiments, the communications link may be established via a wireless interface included in the aerosol delivery device and a wireless interface included in the mobile device.

The mobile device may comprise, for example, a mobile phone, a smart phone, a tablet or a laptop. Establishing the communication link may comprise any suitable steps. For example, it may comprise sharing of an encryption key, a password or a code between the two devices.

The system may further comprise an application server, wherein the aerosol delivery device and/or the mobile device may be configured to communication wirelessly (e.g., via Bluetooth™) with the application server, via a network.

The application installed on the mobile device and the application server may be configured to assist a user with their aerosol delivery device, based on information communicated between the aerosol delivery device, the mobile device and/or the application server.

In a twelfth aspect, there is provided a method of managing an aerosol delivery device, the method comprising the steps of:
detecting that a component is coupled to a device of the aerosol delivery device;
detecting a predetermined movement of the aerosol delivery device; and then
sending an advertising communication to a mobile device.

The method of the twelfth aspect may be a method of managing the aerosol delivery device of the tenth aspect.

Similar to the tenth and the eleventh aspects, the advertising communication may be a request to establish a communication link with the mobile device.

Accordingly, the method may further comprise the step of, after receiving the advertising communication at the mobile device, establishing a communication link between an application installed on the mobile device and the aerosol delivery device.

The predetermined movement may be as described above with respect to the tenth aspect, for example.

In a thirteenth aspect there is provided a method of using the aerosol delivery device according to the tenth aspect, the method comprising:
engaging the component with the device; and
performing a tap sequence on the aerosol delivery device, so as to instruct the aerosol delivery device to pair with a mobile device.

In a fourteenth aspect there is provided an aerosol delivery device including: a movement sensor; a controller; and a feedback means, wherein: the movement sensor is configured to detect rotary motion of the device about an axis, and to transmit a movement detection signal to the controller; and in response to receiving the movement detection signal, the controller is configured to cause the feedback means to output feedback.

Such aerosol delivery devices are effectively equipped with an additional functionality: the ability to output feedback in response to the detection that the device is being rotated by a user. Such a device provides a user with an additional distraction which may be useful in reducing the amount of time which a user spends using the device for vaping or other smoking substitute activity. In this way, the provision of an alternative functionality for the device is useful in aiding the user to give up smoking permanently. In addition to this, by encouraging a user to spin the device, it is possible to ensure that, in embodiments in which the wick is located at the bottom of the consumable component, liquid is moved away from the wick, allowing air to enter the consumable component through the wick, to provide pressure relief to the tank of the consumable component—preventing leakage. Alternatively, when the wick of the consumable component is located at the top of the wick, the spinning will cause liquid to the coat the wick which can reduce the likelihood of burning of the wick. In both cases, spinning of the device causes liquid to better reach the heater through a liquid transfer element, and the provision of a visual output informs the user that they are spinning the device fast enough to give rise to the desired effect.

The movement sensor may be in the form of an accelerometer.

It is preferred that the feedback means is a visual feedback element, and the output is in the form of a visual output, in the form of visible light. In some embodiments, the front or rear surface of a device body of the device may include the visual feedback element, which preferably includes a light source, for example one or more light-emitting diodes LEDs) configured to emit visible light in response to the detection of rotary motion. The device may include a plurality of light sources, preferably a plurality of LEDs. The light sources may be configured to illuminate an illumination region of the device. Alternatively, the lights may be configured to project an image, pattern, or spot of light onto a surface upon which the device is rotating.

The device of any aspect may comprise a source of power which may be a battery, e.g., a rechargeable battery. The source of power may be a capacitor.

The aerosol delivery device of any aspect may include a/the heater. The heater may be used in a vaporizer to vaporize an aerosol precursor.

The device of any aspect may comprise a device body for housing the/a power source and/or other electrical components. The device body may be an elongate body, i.e., with a greater length than depth/width. It may have a greater width than depth.

The device body may have a length of between 5 and 30 cm, e.g., between 10 and 20 cm such as between 10 and 13 cm. The maximum depth of the device body may be between 5 and 30 mm, e.g., between 10 and 20 mm.

In order to describe the geometry of the device, it is useful first to define a front surface, a rear surface, two end surfaces, a transverse axis (and a corresponding transverse direction), and a longitudinal axis (and a corresponding longitudinal direction). The two end surfaces are joined at least by the front surface and the rear surface, and are spaced along the longitudinal axis (so that one must move in the longitudinal direction to go from one end surface to the other). The transverse axis is perpendicular to (or substantially perpendicular to) the longitudinal axis, and extends in a left-right direction, when the front surface is located above the rear surface. A third axis and a third direction may also be defined, which is substantially perpendicular to both the transverse and longitudinal axes (and directions).

The device body may have a front surface that is curved in the transverse dimension. The device body may have a rear surface that is curved in the transverse dimension. Here, curved in a given direction means that a given surface is curved away from the associated axis. Preferably, the points along a line which is said to be curved vary in distance from a straight line or straight axis in a direction which is perpendicular to both the transverse and longitudinal directions, i.e., the points vary in distance from a straight line in the third direction.

The curvatures of the front surface and rear surface may be of the opposite sense to one another. Both front and rear surfaces may be convex in the transverse dimension. They may have an equal radius of curvature.

The radius of curvature of the front surface may be between 10 and 50 mm, preferably between 10 and 40 mm, preferably between 10 and 30 mm, preferably been 10 and 20 mm, more preferably between 10 and 15 mm, more preferably substantially 13.5 mm.

The front and rear surfaces may meet at opposing transverse edges of the device body. This leads to a mandorla-/lemon-/eye-shaped cross sectional shape of the device body.

The transverse edges may have a radius of curvature that is significantly smaller than the radius of curvature of either the front or rear surface. This leads to the transverse edges being substantially “pointed” or “sharp”. The transverse edges may have a radius of curvature in the transverse dimension of less than 10 mm, preferably less than 5 mm, preferably less than 2 mm, preferably less than 1 mm.

The transverse edges may extend substantially the full longitudinal length of the device body. However, in some embodiments, the transverse edges may only extend along a longitudinal portion of the device body.

The device body may have a curved longitudinal axis, i.e., curved in a direction between the front and rear faces.

It should be noted that throughout this description, the term “front surface” is used to refer to the surface which is convex in the longitudinal direction, and the term “rear surface” is used to refer to the term which is concave in the longitudinal direction. By having a convex front surface, when the device is placed on a surface, its area of contact with the surface is reduced, enhancing its ability to spin on that surface, due to a reduction in friction.

In embodiments in which the cross-section of the device is as described above, with two sides which are convex in the transverse direction, e.g., having a mandorla-/lemon-/eye-shaped cross-section, or an elliptical or substantially elliptical cross section, and with a longitudinally-convex rear surface, the area of contact between the rear surface of the device and an external surface may be even further reduced, even further enhancing the ability of the device to spin on that surface. In other words, it is preferable that the front surface is convex in both the longitudinal direction and the transverse direction.

In some embodiments, the device may include a projection or protrusion, preferably on the front surface, on which the device is able to spin, much like the point of a spinning top. Preferably the protrusion is located in a position which is below the center of mass of the device or the device body, in order to ensure that the device is able to balance when spun on a surface.

The rotary motion is preferably rotary motion about an axis which is parallel to the third axis, i.e., the axis which is perpendicular (or substantially perpendicular) to the longitudinal axis and the transverse axis. Specifically, the rotary motion is rotary motion about an axis which is parallel to the third axis, and which is located approximately halfway along the device in both the transverse and longitudinal directions. Such an axis may be referred to as a central axis, and preferably passes through the device's center of mass. In embodiments including the projection or protrusion as discussed in the previous paragraph, it is preferred that the protrusion is located at a point on the front surface of the device body, where the central axis intersects the rear surface, in order to ensure the best balance when the device is rotating on that surface.

In some embodiments, the movement sensor may be configured to detect rotary motion about more than one axis, and the controller may be configured to cause the visual feedback element to display a different visual output depending on about which axis the rotary motion is detected. Specifically, if the movement sensor detects rotation about a first axis (preferably the central axis as defined above), the controller may be configured to cause the visual feedback element to display a first visual output, and if the movement sensor detects rotation about a second axis (for example, an axis which is parallel to the central axis but longitudinally displaced therefore, e.g., located at or close to one of the longitudinal ends of the device body or device), the controller may be configured to cause the visual feedback element to display a second visual output, wherein the second visual output is different from the first visual output.

In some embodiments of the fourteenth aspect, in addition to detecting that rotary motion is taking place, the movement sensor may be further configured to measure, detect or determine one or more properties of the rotary motion, for example the angular velocity, angular acceleration and direction of the motion. The movement detection signal may include movement data which indicates a property of the rotary motion. In some cases, the device may be configured only to output feedback when a value representing a property of the rotary motion exceeds a predetermined threshold. For example, the controller may be configured to compare a value representing a property of the rotary motion with a predetermined threshold value, and only if it is determined that the value representing a property of the rotary motion exceeds the predetermined threshold, the controller may then cause the feedback means to output feedback. When it is detected that the value representing the property of the rotary motion has fallen below the threshold, the controller may be configured to cause the feedback means to stop outputting feedback. The preferred threshold value preferably corresponds to the angular velocity or rate of rotation which gives rise to the desirable technical effect associated with the spinning of the device, which was discussed earlier (i.e., prevention of leakage or prevention of wick burning). The preferred threshold may be determined based on an angular velocity or rate of rotation required to cause movement of liquid in a consumable component engageable with the aerosol delivery device, by centrifugal or centripetal force.

In some cases, the feedback may vary depending on the value representing the property of the rotary motion. For example, if the property of the rotary motion is represented by any of a first range of values, a first type of feedback may be output, and if the property of the rotary motion is represented by any of a second range of values, a second type of feedback may be output, wherein the first range of values and the second range of values are non-overlapping. It will be appreciated that this can straightforwardly be extended to more than two ranges of values and corresponding visual outputs. In embodiments in which the visual outputs are in the form of illuminations generated by a light source such as an LED, the first visual output may be a first color, and the second visual output may be a second color. The visual outputs may include flashing lights or moving lights. In those cases, the frequency with which the lights flash, or speed with which the lights move may vary depending on the value representing the property of the rotary motion.

A visual output may be in the form of a sequence of LEDs illuminating at different times, and may be referred to as an illumination sequence. In some embodiments, the rate at which the illumination sequence is displayed may vary depending on a value representing a property of the rotary motion, preferably the angular velocity. An illumination sequence may be selected so that, depending on the locations of each LED at a given time as the device or device body is rotating, an image or animation is viewable, in the same manner as an image is created by a dot-matrix display. By adjusting the illumination sequence in response to the angular velocity, the correct proportions of the image or animation can be maintained.

In order to prevent leakage, it is preferred that the controller is configured to prevent the action of the heater when rotary motion is detected by the movement sensor. Also, in some embodiments, the controller may only be configured to cause the visual feedback element to display a visual output when the heater is off.

The front and/or rear surface of the device body in any aspect may include the/a visual feedback element, for example one or more lights, e.g., one or more LEDs.

In some embodiments, the device body may include an illumination region configured to allow light provided by a light source (e.g., one or more LEDs) within the device body to shine through.

The visual feedback element, such as the LEDs or the illumination region, may be configured to provide the visual feedback indication(s) in the tenth aspect.

The first feedback indication may include the illumination region continuously emitting white light, for example. The second feedback indication may include the illumination region providing two or more flashes of white light, for example.

The first feedback indication may differ from the second feedback indication.

The device of any aspect may comprise a movement sensor movement sensor (e.g., an accelerometer) for detecting a movement of the device.

The device of any aspect may comprise a haptic feedback generation unit (e.g., an electric motor and a weight mounted eccentrically on a shaft of the electric motor) which may be configured to provide haptic feedback indication(s).

For example, in the tenth aspect, the first and/or second feedback indication may be haptic feedback indications.

Alternatively, or additionally, the first and/or second feedback may be audible feedback indications. The aerosol delivery device of the tenth aspect may comprise a speaker which is configured to produce the audible feedback indication(s).

The device of any aspect may include a controller. The controller may be configured to identify an operation of the smoking substitute device; and control the source of light contained within the device body, to illuminate the illumination region based on the operation of the smoking substitute device identified.

The controller may be configured to control the haptic feedback generation unit to generate the haptic feedback in response to the detection of movement of the system.

A memory may be provided in any of the aspects and may be operatively connected to the controller. The memory may include non-volatile memory. The memory may include instructions which, when implemented, cause the controller to perform certain tasks or steps of a method. The device of any aspect may comprise a wireless interface, which may be configured to communicate wirelessly with another device, for example a mobile device, e.g., via Bluetooth®. To this end, the wireless interface could include a Bluetooth® antenna. Other wireless communication interfaces, e.g., WIFI®, are also possible. The wireless interface may also be configured to communicate wirelessly with a remote server.

An airflow/inhalation (i.e., puff) sensor may be provided in any aspect, the sensor being configured to detect a puff (i.e., inhalation from a user). The airflow/inhalation sensor may be operatively connected to the controller so as to be able to provide a signal to the controller that is indicative of a puff state (i.e., puffing or not puffing). The airflow/inhalation sensor may, for example, be in the form of a pressure sensor or an acoustic sensor. The controller may control power supply to a heating element in response to airflow detection by the sensor. The control may be in the form of activation of the heating element in response to a detected airflow. The airflow/inhalation sensor may form part of the device. The heating element may be used in a vaporizer to vaporize an aerosol precursor. The vaporizer may be housed in a vaporizing chamber.

In a fifteenth aspect, there is provided an aerosol delivery system (e.g., smoking substitute system) comprising a device according to any one of the previous aspects and a component for containing an aerosol precursor.

The component may be an aerosol-delivery (e.g., a smoking substitute) consumable, i.e., in some embodiments the component may be a consumable component for engagement with the aerosol-delivery (e.g., a smoking substitute) device to form the aerosol-delivery (e.g., smoking substitute) system.

The device may be configured to receive the consumable component. The device and the consumable component may be configured to be physically coupled together. For example, the consumable component may be at least partially received in a recess of the device, such that there is snap engagement between the device and the consumable component. Alternatively, the device and the consumable component may be physically coupled together by screwing one onto the other, or through a bayonet fitting.

Thus, the consumable component may comprise one or more engagement portions for engaging with the device.

The consumable component may comprise an electrical interface for interfacing with a corresponding electrical interface of the device. One or both of the electrical interfaces may include one or more electrical contacts (which may extend through the transverse plate of the lower portion of the insert). Thus, when the device is engaged with the consumable component, the electrical interface may be configured to transfer electrical power from the power source to a heating element of the consumable component. The electrical interface may also be used to identify the consumable component from a list of known types. The electrical interface may additionally or alternatively be used to identify when the consumable component is connected to the device.

The device may alternatively or additionally be able to detect information about the consumable component via an RFID reader, a barcode or QR code reader. This interface may be able to identify a characteristic (e.g., a type) of the consumable. In this respect, the consumable component may include any one or more of an RFID chip, a barcode or QR code, or memory within which is an identifier and which can be interrogated via the interface.

In other embodiments, the component may be integrally formed with the aerosol-delivery (e.g., a smoking substitute) device to form the aerosol-delivery (e.g., smoking substitute) system.

In such embodiments, the aerosol former (e.g., e-liquid) may be replenished by re-filling a tank that is integral with the device (rather than replacing the consumable). Access to the tank (for re-filling of the e-liquid) may be provided via, e.g., an opening to the tank that is sealable with a closure (e.g., a cap).

The aerosol delivery system may comprise an airflow path therethrough, the airflow path extending from an air inlet to an outlet. The outlet may be at a mouthpiece portion of the component. In this respect, a user may draw fluid (e.g., air) into and along the airflow path by inhaling at the outlet (i.e., using the mouthpiece).

The airflow path passes the vaporizer between the air inlet to the air outlet.

The airflow path may comprise a first portion extending from the air inlet towards the vaporizer. The second portion of the airflow path passes through the vaporizing chamber to a conduit that extends to the air outlet. The conduit may extend along the axial center of the component.

References to “downstream” in relation to the airflow path are intended to refer to the direction towards the air outlet/outlet portion. Thus, the second and third portions of the airflow path are downstream of the first portion of the airflow path. Conversely, references to “upstream” are intended to refer to the direction towards the air inlet. Thus, the first portion of the airflow path (and the air inlet) is upstream of the second/third portions of the airflow path (and the air outlet/outlet portion).

References to “upper”, “lower”, “above” or “below” are intended to refer to the component when in an upright/vertical orientation, i.e., with elongate (longitudinal/length) axis of the component vertically aligned and with the mouthpiece vertically uppermost.

The component may comprise a tank for housing the aerosol precursor (e.g., a liquid aerosol precursor). The aerosol precursor may comprise an e-liquid, for example, comprising a base liquid and, e.g., nicotine. The base liquid may include propylene glycol and/or vegetable glycerin.

At least a portion of one of the walls defining the tank may be translucent or transparent.

The conduit may extend through the tank with the conduit walls defining an inner region of the tank. In this respect, the tank may surround the conduit, e.g., the tank may be annular.

As discussed above, the air flow path passes the vaporizer between the air inlet to the air outlet. The vaporizer may comprise a wick, e.g., an elongate wick which may have a cylindrical shape.

The wick may be oriented so as to extend in the direction of the width dimension of the component (perpendicular to the longitudinal axis of the component). Thus, the wick may extend in a direction perpendicular to the direction of airflow in the airflow path.

The vaporizer may be disposed in the vaporizing chamber. The vaporizing chamber may form part of the airflow path.

The wick may comprise a porous material. A portion of the wick may be exposed to airflow in the airflow path. The wick may also comprise one or more portions in contact with liquid aerosol precursor stored in the tank. For example, opposing ends of the wick may protrude into the tank and a central portion (between the ends) may extend across the airflow path so as to be exposed to airflow. Thus, fluid may be drawn (e.g., by capillary action) along the wick, from the tank to the exposed portion of the wick.

The heating element may be in the form of a filament wound about the wick (e.g., the filament may extend helically about the wick). The filament may be wound about the exposed portion of the wick. The heating element is electrically connected (or connectable) to the power source. Thus, in operation, the power source may supply electricity to (i.e., apply a voltage across) the heating element so as to heat the heating element. This may cause liquid stored in the wick (i.e., drawn from the tank) to be heated so as to form a vapor and become entrained in airflow along the airflow path. This vapor may subsequently cool to form an aerosol, e.g., in the conduit.

In a sixteenth aspect, there is provided a charging case for an aerosol delivery device, the charging case comprising:
a battery, for providing power to a source of power of the aerosol delivery device; and
a cavity, for receiving the aerosol delivery device, wherein the cavity includes a first electrical contact and a second electrical contact on a bottommost surface or one or more lateral sides thereof, arranged to contact to corresponding electrical contacts on one end of the aerosol delivery device.

The bottommost surface of the cavity may be the surface distalmost from an aperture through which the aerosol delivery device is introduced into the cavity. The cavity may contain only the first electrical contact and second electrical contact, and may not include a USB connector.

The first electrical contact and second electrical contact, forming a pair of contacts, may be on opposite lateral sides of the cavity. The first electrical contact and second electrical contact, forming a pair of contacts, may be on a same lateral side of the cavity.

In a seventeenth aspect, there is provided a system, comprising:
an aerosol delivery device according to the first aspect, and
a charging case, according to the sixteenth aspect.

In an eighteenth aspect there is provided a method of using the aerosol-delivery (e.g., smoking substitute) system according to any aspect, the method comprising engaging the consumable component with an aerosol-delivery (e.g., smoking substitute) device (as described above) having a power source so as to electrically connect the power source to the consumable component (i.e., to the vaporizer of the consumable component).

The disclosure includes the combination of the aspects and preferred features described except where such a combination is clearly impermissible or expressly avoided.

### BRIEF DESCRIPTION OF THE DRAWINGS

So that further aspects and features thereof may be appreciated, embodiments will now be discussed in further detail with reference to the accompanying figures, in which:

FIG. 1A is a front schematic view of a smoking substitute system;

FIG. 1B is a front schematic view of a device of the system;

FIG. 1C is a front schematic view of a component of the system;

FIG. 2 is a front schematic view of a variant smoking substitute system;

FIG. 3A is a front schematic view of a variant smoking substitute device;

FIG. 3B is a front schematic view of a variant smoking substitute device;

FIG. 4A is a schematic of the components of the device;

FIG. 4B is a schematic of the components of the component;

FIG. 5 is a section view of a component;

FIG. 6A is a perspective view of a smoking substitute system according to the first aspect;

FIG. 6B is a perspective view of a smoking substitute system according to other aspects;

FIG. 7 is a section view of the smoking substitute apparatus;

FIG. 8 is a schematic view of a charging case;

FIG. 9A is a schematic view of a variant charging case;

FIG. 9B is a schematic view of a variant charging case;

FIG. 10. is a perspective view of a smoking substitute system according to the second aspect;

FIG. 11 is a schematic of the components of the device according to another aspect;

FIG. 12 is flow diagram illustrating the operation of the device shown in FIG. 11;

FIG. 13 is a perspective view of the device shown in FIG. 11;

FIG. 14 a perspective view of the device according to another embodiment;

FIG. 15a is a front view of the device showing full illumination level;

FIG. 15b is a front view of the device showing a partial illumination level;

FIG. 15c is a front view of the device showing a zero illumination level;

FIG. 16 is a flow chart illustrating operation of a controller of a smoking substitute device according to another aspects;

FIG. 17 is a flow chart illustrating a method of determining whether a smoking substitute device is in an idle state; and

FIG. 18 is a flow chart illustrating a variation of the method of FIG. 17;

FIG. 19 is a diagram of steps performed by the device;

FIGS. 20 and 21 show examples of methods which may be performed by devices of the ninth aspect;

FIG. 22 shows an example system for managing the smoking substitute device of the tenth aspect; and

FIG. 23 is a flowchart of operations which can be performed by the smoking substitute device of the tenth aspect.

### DETAILED DESCRIPTION OF THE EMBODIMENTS

Aspects and embodiments will now be discussed with reference to the accompanying figures. Further aspects and embodiments will be apparent to those skilled in the art.

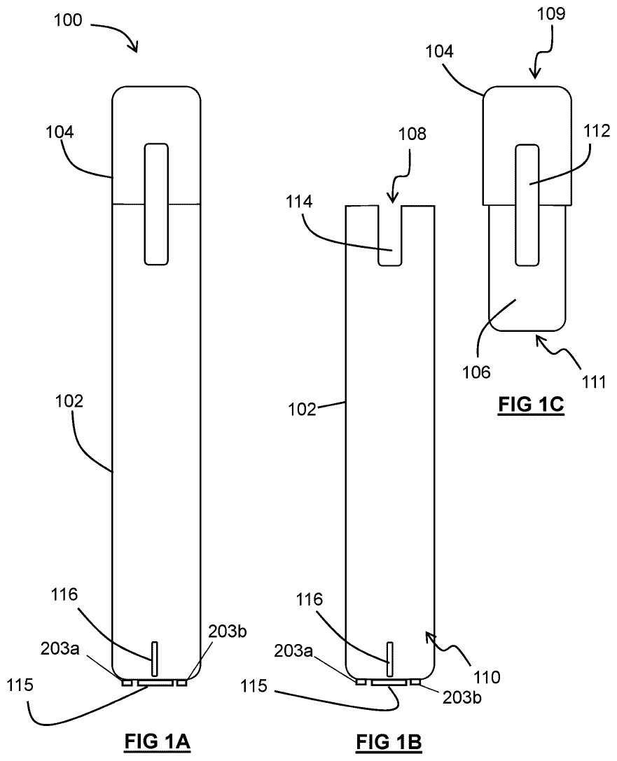

FIG. 1A shows a first embodiment of a smoking substitute system 100. In this example, the smoking substitute system 100 includes a device 102 and a component 104. The component 104 may alternatively be referred to as a “pod”, “cartridge” or “cartomizer”. It should be appreciated that in other examples (i.e., open systems), the device may be integral with the component. In such systems, a tank of the aerosol delivery system may be accessible for refilling the device.

In this example, the smoking substitute system 100 is a closed system vaping system, wherein the component 104 includes a sealed tank 106 and is intended for single-use only. The component 104 is removably engageable with the device 102 (i.e., for removal and replacement). FIG. 1A shows the smoking substitute system 100 with the device 102 physically coupled to the component 104, FIG. 1B shows the device 102 of the smoking substitute system 100 without the component 104, and FIG. 1C shows the component 104 of the smoking substitute system 100 without the device 102.

The device 102 and the component 104 are configured to be physically coupled together by pushing the component 104 into a cavity at an upper end 108 of the device 102, such that there is an interference fit between the device 102 and the component 104. In other examples, the device 102 and the component may be coupled by screwing one onto the other, or through a bayonet fitting.

The component 104 includes a mouthpiece (not shown in FIG. 1A, 1B or 1C at an upper end 109 of the component 104, and one or more air inlets (not shown) in fluid communication with the mouthpiece such that air can be drawn into and through the component 104 when a user inhales through the mouthpiece. The tank 106 containing e-liquid is located at the lower end 111 of the component 104.

The tank 106 includes a window 112, which allows the amount of e-liquid in the tank 106 to be visually assessed. The device 102 includes a slot 114 so that the window 112 of the component 104 can be seen whilst the rest of the tank 106 is obscured from view when the component 104 is inserted into the cavity at the upper end 108 of the device 102.

The lower end 110 of the device 102 also includes a light 116 (e.g., an LED) located behind a small translucent cover. The light 116 may be configured to illuminate when the smoking substitute system 100 is activated. Whilst not shown, the component 104 may identify itself to the device 102, via an electrical interface, RFID chip, or barcode.

The lower end 110 of the device 102 also includes a first charging connection, e.g., a USB connection 115, which is usable to charge a battery within the device 102. Specifically, in this example, a type C USB connection is provided. The charging connection 115 can also be used to transfer data to and from the device, for example to update firmware thereon. The lower end 110 of the device 102 also includes a second charging connector, in this example a pair of electrical contacts 203a and 203b. The second charging connector can be used to charge the device, for example, when placed in a charging case. The contacts 203a and 203b may protrude from the housing of device 102, and may be spring-loaded, and biased to an outwards position. The contacts may be formed from gold plated copper, or a similar conductive material.

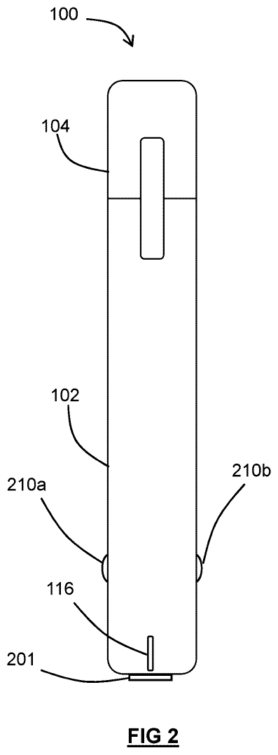

FIG. 2 shows a variant device 102. Where the device 102 in FIG. 2 shares features with the device shown in FIGS. 1A and 1B, like features are indicated by like reference numerals.

The lower end 110 of the device 102 in FIG. 2 includes a USB socket 115, which is usable to charge a battery within the device 102. The USB socket can also be used to transfer data to and from the device, for example to update firmware thereon. In addition to the USB socket 115, a second charging connection, formed of contacts 202a and 202b, is provided on opposing lateral sides of the device 102. Contacts 202a and 202b electrically connect to a source of power, for example in a carry case suitable for the smoking substitute device 102. Contacts 202a and 202b may be spring-loaded, and biased to an outwards position. Alternatively, the contacts may be flat plate contacts so as to conform to the outer shape of the device.

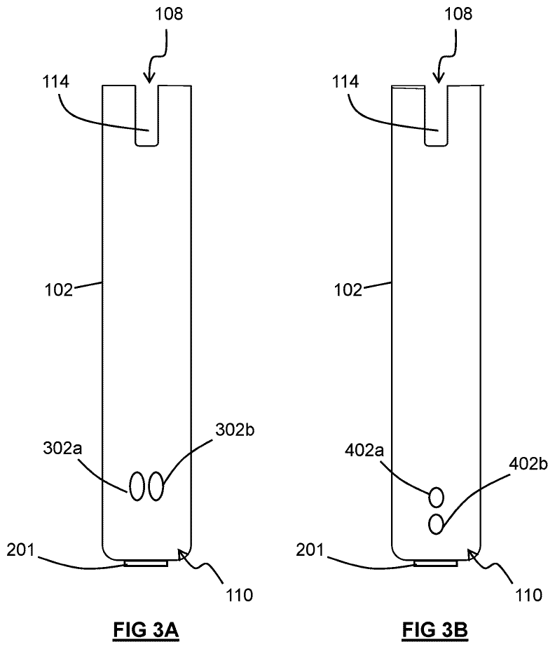

FIGS. 3A and 3B show variant smoking substitute devices 102, where like features are indicated by like reference numerals. In FIG. 3A, the electrical contacts 302a and 302b of the second charging connection are provided on a same lateral side of the device 102. In this instance, the contacts are horizontally spaced, so as to be provided in a row extending across a width of the device (left-right in FIG. 3A).

In FIG. 3B, the electrical contacts 402a and 402b of the second charging connection are again provided on a same lateral side of the device 102. However, in this instance, the contacts are vertically spaced, so as to be provided in a row extending along a length of the device away from the first charging connection 115 (up-down in FIG. 3B).

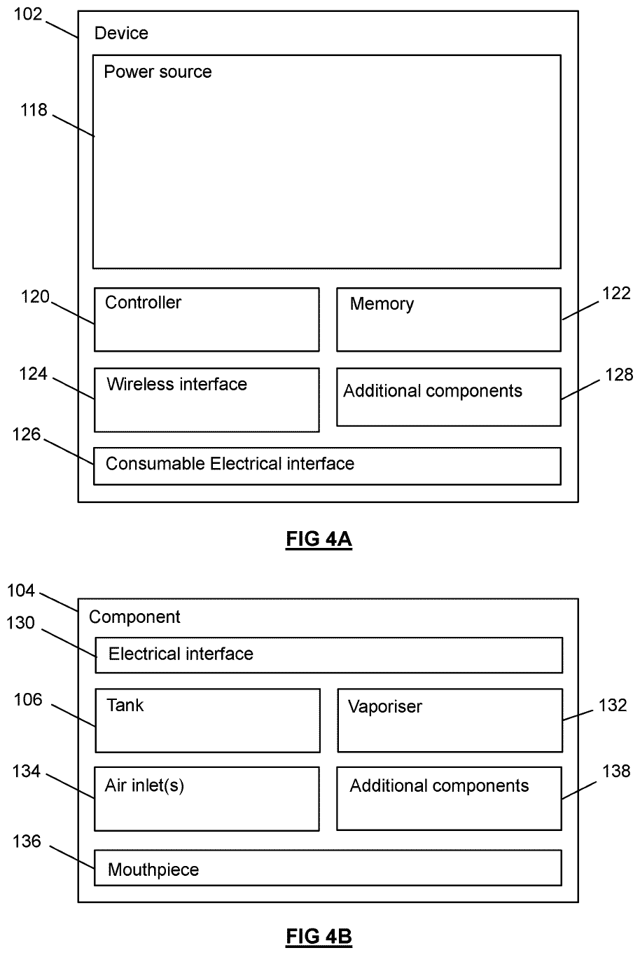

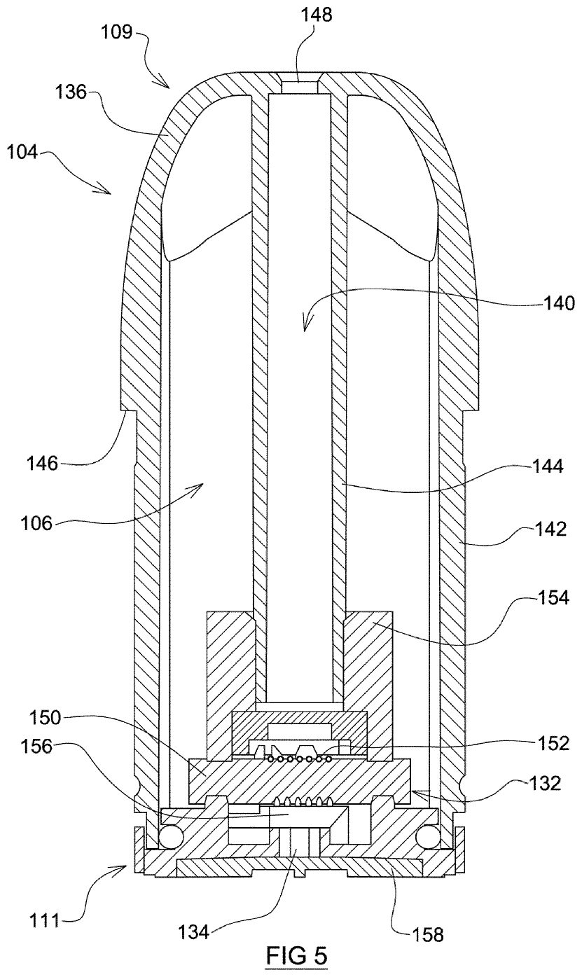

FIGS. 4A and 4B are schematic drawings of the device 102 and component 104. As is apparent from FIG. 4A, the device 102 includes a power source 118, a controller 120, a memory 122, a wireless interface 124, an electrical interface 126, and, optionally, one or more additional components 128.

The power source 118 is preferably a battery, more preferably a rechargeable battery. The controller 120 may include a microprocessor, for example. The memory 122 preferably includes non-volatile memory. The memory may include instructions which, when implemented, cause the controller 120 to perform certain tasks or steps of a method.

The wireless interface 124 is preferably configured to communicate wirelessly with another device, for example a mobile device, e.g., via Bluetooth®. To this end, the wireless interface 124 could include a Bluetooth® antenna. Other wireless communication interfaces, e.g., WIFI®, are also possible. The wireless interface 124 may also be configured to communicate wirelessly with a remote server.

The electrical interface 126 of the device 102 may include one or more electrical contacts. The electrical interface 126 may be located in a base of the aperture in the upper end 108 of the device 102. When the device 102 is physically coupled to the component 104, the electrical interface 126 is configured to transfer electrical power from the power source 118 to the component 104 (i.e., upon activation of the smoking substitute system 100).

The electrical interface 126 may also be used to identify the component 104 from a list of known components. For example, the component 104 may be a particular flavor and/or have a certain concentration of nicotine (which may be identified by the electrical interface 126). This can be indicated to the controller 120 of the device 102 when the component 104 is connected to the device 102. Additionally, or alternatively, there may be a separate communication interface provided in the device 102 and a corresponding communication interface in the component 104 such that, when connected, the component 104 can identify itself to the device 102.

The additional components 128 of the device 102 may comprise the light 116 discussed above.

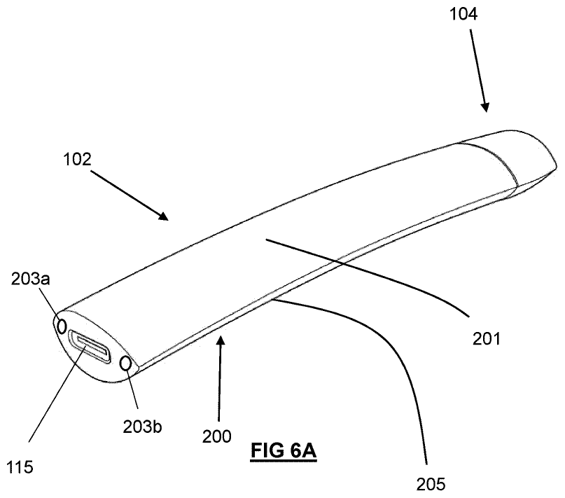

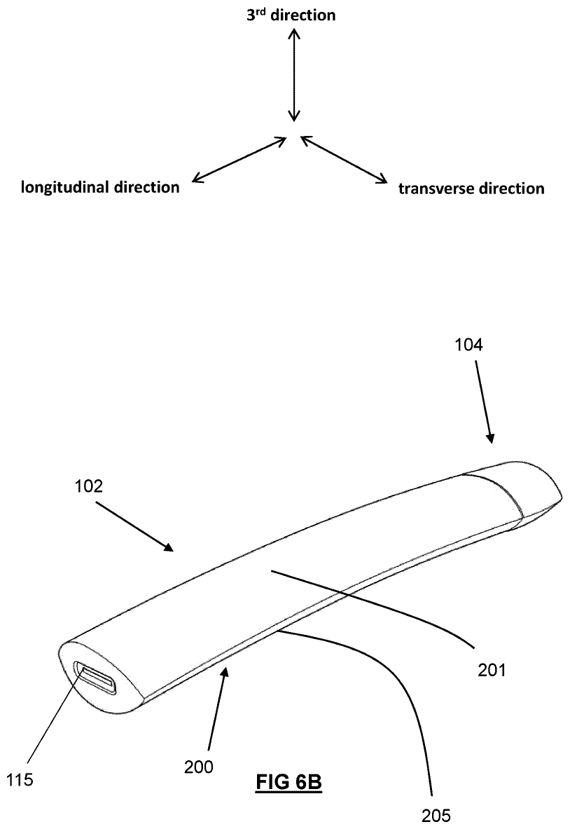

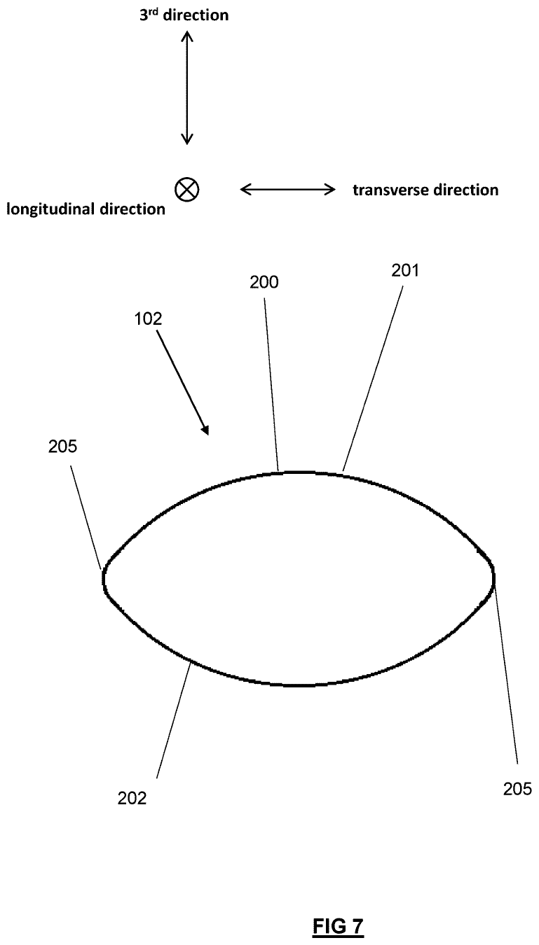

The additional components 128 of the device 102 also comprises the first charging connection 115 configured to receive power from the charging station (i.e., when the power source 118 is a rechargeable battery) and the second charging connection 203a and 203b, 210a and 210b, 302a and 302b, and 402a and 402b. These may be located at the lower end 110 of the device 102 as discussed with reference to FIGS. 1A, 1B, and 6, or on the lateral sides therefore as discussed with reference to FIGS. 2-3B.

The additional components 128 of the device 102 may, if the power source 118 is a rechargeable battery, include a battery charging control circuit, for controlling the charging of the rechargeable battery. However, a battery charging control circuit could equally be located in the charging station (if present).

The additional components 128 of the device 102 may include a sensor, such as an airflow/inhalation (i.e., puff) sensor for detecting airflow in the smoking substitute system 100, e.g., caused by a user inhaling through a mouthpiece 136 of the component 104. The smoking substitute system 100 may be configured to be activated when airflow is detected by the airflow sensor. This sensor could alternatively be included in the component 104. The airflow sensor can be used to determine, for example, how heavily a user draws on the mouthpiece or how many times a user draws on the mouthpiece in a particular time period.

The additional components 128 of the device 102 may include a user input, e.g., a button. The smoking substitute system 100 may be configured to be activated when a user interacts with the user input (e.g., presses the button). This provides an alternative to the airflow sensor as a mechanism for activating the smoking substitute system 100.

As shown in FIG. 4B, the component 104 includes the tank 106, an electrical interface 130, a vaporizer 132, one or more air inlets 134, a mouthpiece 136, and one or more additional components 138.

The electrical interface 130 of the component 104 may include one or more electrical contacts. The electrical interface 126 of the device 102 and an electrical interface 130 of the component 104 are configured to contact each other and thereby electrically couple the device 102 to the component 104 when the lower end 111 of the component 104 is inserted into the upper end 108 of the device 102 (as shown in FIG. 1A). In this way, electrical energy (e.g., in the form of an electrical current) is able to be supplied from the power source 118 in the device 102 to the vaporizer 132 in the component 104.

The vaporizer 132 is configured to heat and vaporize e-liquid contained in the tank 106 using electrical energy supplied from the power source 118. As will be described further below, the vaporizer 132 includes a heating filament and a wick. The wick draws e-liquid from the tank 106 and the heating filament heats the e-liquid to vaporize the e-liquid.

The one or more air inlets 134 are preferably configured to allow air to be drawn into the smoking substitute system 100, when a user inhales through the mouthpiece 136. When the component 104 is physically coupled to the device 102, the air inlets 134 receive air, which flows to the air inlets 134 along a gap between the device 102 and the lower end 111 of the component 104.

In operation, a user activates the smoking substitute system 100, e.g., through interaction with a user input forming part of the device 102 or by inhaling through the mouthpiece 136 as described above. Upon activation, the controller 120 may supply electrical energy from the power source 118 to the vaporizer 132 (via electrical interfaces 126, 130), which may cause the vaporizer 132 to heat e-liquid drawn from the tank 106 to produce a vapor which is inhaled by a user through the mouthpiece 136.

An example of one of the one or more additional components 138 of the component 104 is an interface for obtaining an identifier of the component 104. As discussed above, this interface may be, for example, an RFID reader, a barcode, a QR code reader, or an electronic interface which is able to identify the component. The component 104 may, therefore include any one or more of an RFID chip, a barcode or QR code, or memory within which is an identifier and which can be interrogated via the electronic interface in the device 102.

It should be appreciated that the smoking substitute system 100 shown in FIGS. 1A to 4B is just one exemplary implementation of a smoking substitute system. For example, the system could otherwise be in the form of an entirely disposable (single-use) system or an open system in which the tank is refillable (rather than replaceable).

FIG. 5 is a section view of the component 104 described above. The component 104 comprises a tank 106 for storing e-liquid, a mouthpiece 136 and a conduit 140 extending along a longitudinal axis of the component 104. In the illustrated embodiment the conduit 140 is in the form of a tube having a substantially circular transverse cross-section (i.e., transverse to the longitudinal axis). The tank 106 surrounds the conduit 140, such that the conduit 140 extends centrally through the tank 106.

A tank housing 142 of the tank 106 defines an outer casing of the component 104, whilst a conduit wall 144 defines the conduit 140. The tank housing 142 extends from the lower end 111 of the component 104 to the mouthpiece 136 at the upper end 109 of the component 104. At the junction between the mouthpiece 136 and the tank housing 142, the mouthpiece 136 is wider than the tank housing 142, so as to define a lip 146 that overhangs the tank housing 142. This lip 146 acts as a stop feature when the component 104 is inserted into the device 102 (i.e., by contact with an upper edge of the device 102).

The tank 106, the conduit 140 and the mouthpiece 136 are integrally formed with each other so as to form a single unitary component and may, e.g., be formed byway of an injection molding process. Such a component may be formed of a thermoplastic material such as polypropylene.

The mouthpiece 136 comprises a mouthpiece aperture 148 defining an outlet of the conduit 140. The vaporizer 132 is fluidly connected to the mouthpiece aperture 148 and is located in a vaporizing chamber 156 of the component 104. The vaporizing chamber 156 is downstream of the inlet 134 of the component 104 and is fluidly connected to the mouthpiece aperture 148 (i.e., outlet) by the conduit 140.

The vaporizer 132 comprises a porous wick 150 and a heater filament 152 coiled around the porous wick 150. The wick 150 extends transversely across the chamber vaporizing 156 between sidewalls of the chamber 156 which form part of an inner sleeve 154 of an insert 158 that defines the lower end 111 of the component 104 that connects with the device 102. The insert 158 is inserted into an open lower end of the tank 106 so as to seal against the tank housing 142.

In this way, the inner sleeve 154 projects into the tank 106 and seals with the conduit 140 (around the conduit wall 144) so as to separate the vaporizing chamber 156 from the e-liquid in the tank 106. Ends of the wick 150 project through apertures in the inner sleeve 154 and into the tank 106 so as to be in contact with the e-liquid in the tank 106. In this way, e-liquid is transported along the wick 150 (e.g., by capillary action) to a central portion of the wick 150 that is exposed to airflow through the vaporizing chamber 156. The transported e-liquid is heated by the heater filament 152 (when activated, e.g., by detection of inhalation), which causes the e-liquid to be vaporized and to be entrained in air flowing past the wick 150. This vaporized liquid may cool to form an aerosol in the conduit 140, which may then be inhaled by a user.

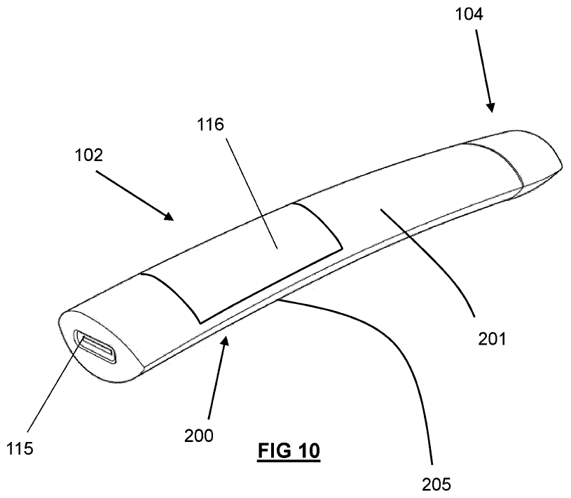

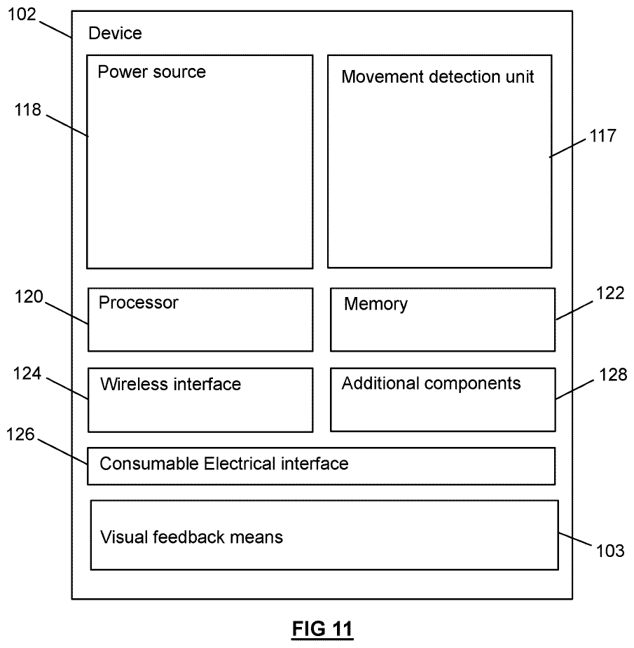

FIGS. 6A, 6B and 10 show perspectives view of embodiments of the device 102 engaged with the component 104 at the upper end 108. The device 102 in FIG. 6A includes a first charging connection, in this example a USB connector 115, at the lower end 110, and a second charging connection formed of first 203a and second 203b electrical contacts on the same lower end 110. The devices in FIGS. 6B and 10 include a charging connection 115 at the lower end 110. The longitudinal, transverse, and third directions are annotated on FIG. 6B but are equally applicable to FIGS. 6A and 11.

The front surface 201 of the device body 200 is curved in the transverse dimension. The rear surface 202 of the device body 200 is curved in the transverse dimension. The curvatures of the front surface 201 and rear surface 202 are of the opposite sense to one another. Both front and rear surfaces 201, 202 are convex in the transverse dimension. This leads to a mandorla-/lemon-/eye-shaped cross sectional shape of the device body 200.

The front surface 201 in the device shown in FIG. 10 includes a visual feedback element 116 of the type discussed previously.

The front surface 201 and rear surface 202 meet at two transverse edges 205. The transverse edges 205 have a radius of curvature that is significantly smaller than the radius of curvature of either the front 201 or rear surface 202. This leads to the transverse edges being substantially “pointed” or “sharp”. The transverse edges may have a radius of curvature in the transverse dimension of less than 1 millimeter.

As illustrated in FIGS. 6A, 6B and 10, the transverse edges 205 extend substantially the full longitudinal length of the device body 200.

The front surface 201 of the device body 200 may include a visual feedback element.

FIG. 7 illustrates a schematic transverse cross section through the device 102 of FIGS. 6A, 6B and 10. The front surface 201 and rear surface 202 are shown meeting at the transverse edges 205 on either side of the device body 200. The radius of curvature in the transverse dimension of the front surface 201 is equal to the radius of curvature in the transverse dimension of the rear surface 202.

The radius of curvature of the front surface 201 may be between 10 and 15 mm.

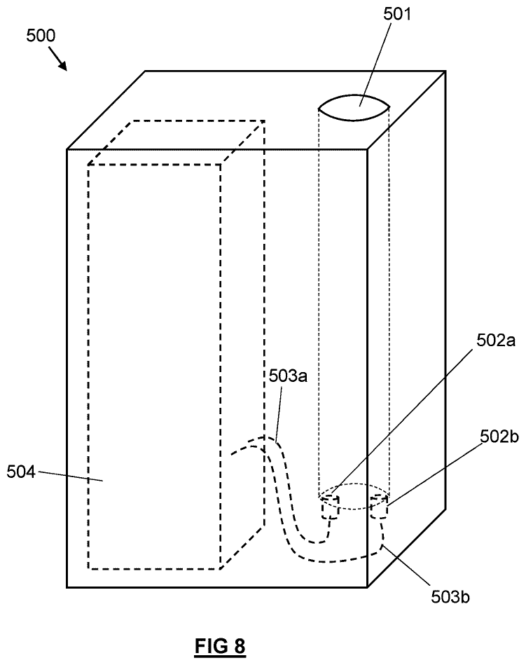

FIG. 8 shows a charging case 500 for use with the aerosol delivery device discussed above with reference to FIGS. 1A, 1B, and 6A. The charging case has a cavity 501, with an aperture located in one surface of the charging case though which the aerosol delivery device can be introduced. Within the cavity, on a bottom most surface of the internal surface thereof, are electrical connectors 502a and 502b. These electrically connect with connectors 203a and 203b on the device 102. Wires 503a and 503b are connected to the connectors 502a and 502b, and electrically interconnect them to battery 504 (which may contain charging electronics, for example voltage regulators and/or processors for controlling the charging process).

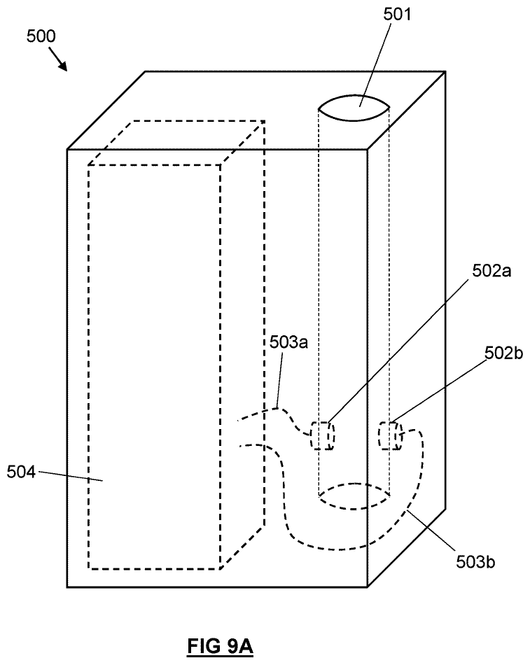

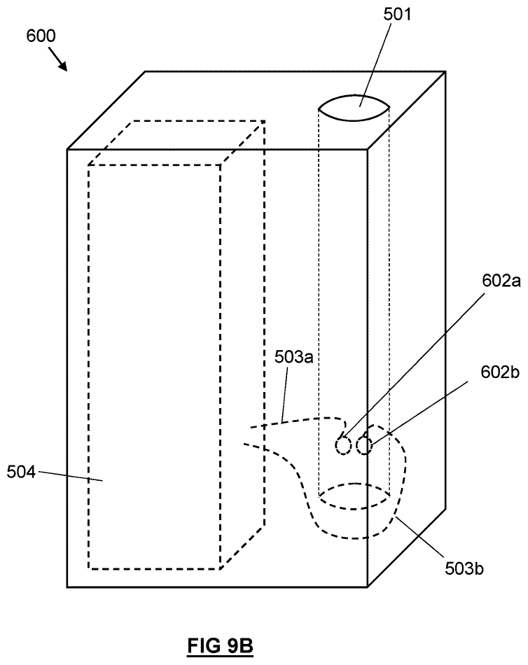

FIG. 9A shows a variant charging case 500 for use with the aerosol delivery device discussed above with reference to FIG. 2. The charging case has a cavity 501, with an aperture located in one surface of the charging case through which the smoking substitute device can be introduced. Within the cavity, on two lateral sides of the internal surface thereof, are electrical connectors 502a and 502b. These electrically connect with connectors 202a and 202b on device 102. Wires 503a and 503b are connected to the connectors 502a and 502b, and electrically interconnect them to battery 504 (which may contain charging electronics, for example voltage regulators and/or processors for controlling the charging process).

Electrical connectors 502a and 502b may be pogo pin connectors, in that they may be biased towards the interior of the cavity 501 so as to ensure a reliable connection between themselves and the corresponding connectors on device 102.

FIG. 9B shows a variant charging case 600 for use with the aerosol delivery device as discussed above with reference to FIG. 3A. Where case 600 shares features with case 500, like features are indicated by like reference numerals. In contrast to the case 500 shown in FIG. 9A, electrical connectors 602a and 602b are located on a same lateral side of the interior of the cavity 501 and are arranged in a row. In a variation of FIG. 9B, the electrical connectors 602a and 602b are arranged in a column, so as to correspond with the electrical contacts 402a and 402b of the aerosol delivery device shown in FIG. 3B.

FIG. 11 is a schematic drawing of the device 102 according to another aspect. As is apparent from FIG. 10, this embodiment of the device 102 includes a power source 118, a controller 120, a memory 122, a wireless interface 124, an electrical interface 126, a movement sensor 117, and a visual feedback element 103. In this way, the embodiment of the device 102 shown in FIG. 11 is otherwise similar to the embodiment shown in FIG. 4A, with the exception of the movement sensor 117 and the visual feedback element 103. The device 102 shown in FIG. 11 is configured to connect to the component 104.

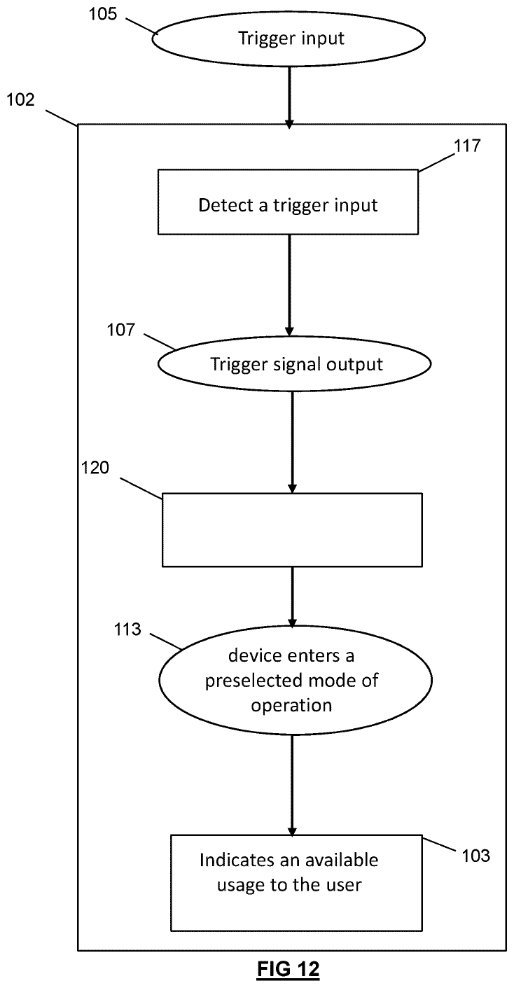

FIG. 12 is a flow diagram illustrating the operating steps associated with the device 102, as illustrated in FIG. 11. Referring to FIG. 12, the movement sensor 117 is configured to detect a trigger input 105 from a user. In one embodiment, the trigger input 105 is in the form of the user tapping on the body 200 of the device 102. The movement sensor 117 is then configured to output a trigger signal 107 to the controller 120. In response to receiving the trigger signal 107, the controller 120 is configured to cause the device 102 to enter a preselected mode of operation 113. Once the device 102 is operating in the preselected mode 113, the visual feedback element 103 is then configured to indicate an available usage of the device to the user.

An associated advantage of this is that the visual feedback element 103 is able to indicate an available usage of the device 102 to the user. This allows the user to visually keep track of their usage, and/or visually determine a usage time in a way they may be already accustomed to when using conventional tobacco-burning products. As such, many potential users may feel more comfortable using (or switching to) the device 102 from conventional tobacco-burning products. Furthermore, the device 102 also provides an easy way for the user to determine the available usage in a readily accessible way (i.e., by a visual feedback element 103), which is further advantageous over known e-cigarette (or “vaping”) devices. In other words, the device 102 advantageously provides a “temporal feel” for the user, typically only associated with conventional tobacco-burning products. In this way, the user of the device 102 is advantageously provided with an e-smoking experience which more closely mimics the behavior of a conventional cigarette or cigar. As a result, this may further advantageously make the user more comfortable, or at ease with, with using the device 102.

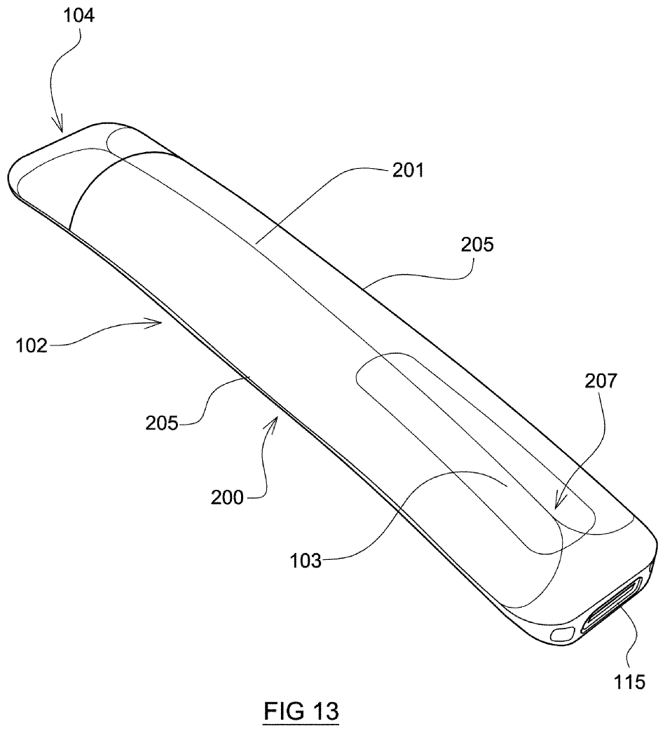

FIG. 13 shows a more detailed perspective view of an embodiment of the same device 102 illustrated in FIG. 11 and in FIG. 12.

Analogous to the embodiment of the device 102 shown in both FIGS. 1A and 1n FIG. 6B, the device 102 shown in FIG. 13 is configured to be engaged with the component 104 at the upper end 108, in the same way as previously described. Similarly, the device 102 also includes a charging connection 115 at the lower end 110. Referring to FIG. 13, the front surface 201 of the device body 200 is curved in the transverse dimension. The rear surface 202 of the device body 200 is curved in the transverse dimension. The curvatures of the front surface 201 and rear surface 202 are of the opposite sense to one another. Both front and rear surfaces 201, 202 are convex in the transverse dimension. This leads to a mandorla-/lemon-/eye-shaped cross sectional shape of the device body 200. The front surface 201 and rear surface 202 meet at two transverse edges 205. The transverse edges 205 have a radius of curvature that is significantly smaller than the radius of curvature of either the front 201 or rear surface 202. This leads to the transverse edges being substantially “pointed” or “sharp”. The transverse edges may have a radius of curvature in the transverse dimension of less than 1 millimeter. As also illustrated in FIG. 13, the transverse edges 205 extend substantially the full longitudinal length of the device body 200. The front surface 201 of the device body 200 may include visual feedback element 206.

In one embodiment of the device 102, the visual feedback element 103 comprises at least one light source 206. The at least one light source 206 may be a plurality of light sources, such as an array of LEDs or light bulbs arranged along the body of the device in order to form an illumination region. Alternatively, or additionally, the at least one light source 206 may be a single light source, such as a single bulb, or a single LED strip.

To illustrate when the device 102 is in use, the user is be able to provide a trigger input 105 to cause the device 102 to enter a preselected mode of operation 113, as is illustrated in FIG. 12. In one embodiment, one such preselected mode of operation 113 is a “burn down” mode, whereby the device 102 provides a visual feedback, via the visual feedback element 103, in the form of a light source. The light source 206 mimics the behavior of a conventionally lit (i.e., ignited or burning) cigarette or cigar. One advantage is that the light source 206 can be easily seen in dark, or seen low lit areas, or in areas with low ambient light. Another associated advantage is that to the light source 206 is able to mimic the burning or glowing embers associated with conventional tobacco-burning products. In this way, the user of the device 102 is advantageously provided with an e-smoking experience which more closely mimics the behavior of a conventional cigarette or cigar. Again, this may further advantageously make the user more comfortable, or at ease with, with using an e-cigarette device. As the skilled person will appreciate, the preselected mode of operation 113 is not limited to the previously described “burn down” mode 113, and may refer to any mode of operation 113 of the device 102.

The light source 206 is shown FIG. 13 in the form a faded out “light pipe” 207 being emitted the at least one light source 206, through the front surface 201 of the device 102. The light pipe 207 also extends along the longitudinal length of the body 200, and along the front surface 201, of the device 102. In one embodiment, the light pipe 207 is brighter at one end, and becomes progressively less bright (or more faded) when moving along the longitudinal axis of the device 102, along the front surface 201, towards the opposite end of the light pipe 207.

In the embodiment shown in FIG. 13, the light pipe 207 is brightest at an end nearest to the lower end 110 of the device 102 (near to the charging connection 115), and becomes progressively more faded at an opposite end, nearest to the component 104. The light pipe 207 is not limited to the specific configuration shown in FIG. 13 and, as the skilled person will appreciate, the light pipe 207 may instead be orientated in a plurality of different ways (not shown in the figures). Furthermore, as the skilled person will further appreciate, the light source 206 is not limited to the specific form of the light pipe 207 (as shown in FIG. 13), and may take any other two-dimensional shape or form, such as incremented or segmented bar, or a dashed line, to give just a few examples.

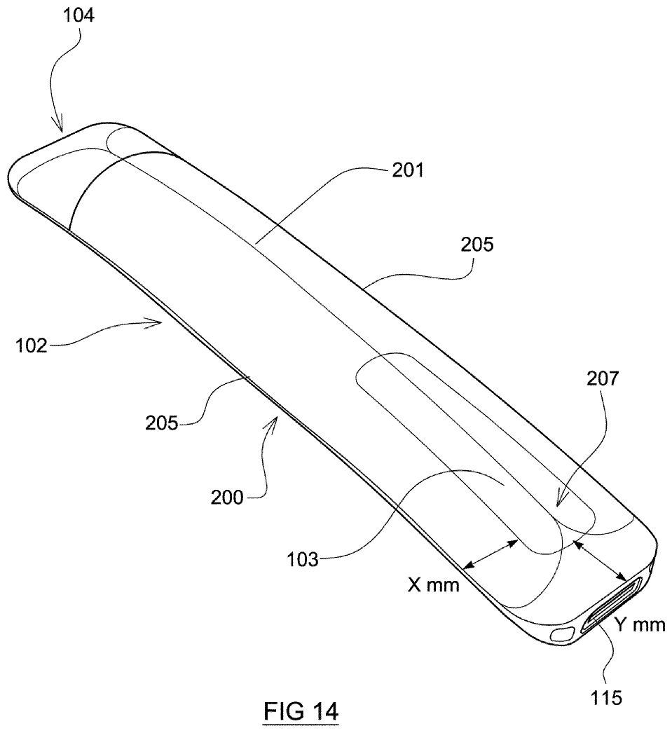

FIG. 14 shows a perspective view of the device according to another embodiment of the device 102 shown in FIG. 13, whereby the colors of the emitted light from the light source 206 are different. Referring to the embodiments shown in FIGS. 13 and 14, the body 200 of the device 102 comprises a light diffusion plastic for diffusing light produced by the at least one light source 206. In the embodiments shown the material covering at least the illuminated light pipe 207 is formed of a light diffusion plastic. In other embodiments, the area covering the entire longitudinal length of the body 200, and along the entire front surface 201 of the device 102, is formed from a light diffusion plastic

An associated advantage of using light diffusion plastic is that it is able to diffuse light produced by the at least one light source 206. As a result, the diffusion of light creates a visual effect which resembles the gradual light-fade associated with the burning (or burning out) or glowing embers in conventional tobacco-burning products. This is also referred to as a “feathering” effect. In other words, the diffusion plastic may advantageously be able to remove the stark glow of artificial light produced by the light source 206, as is typically produced in known e-cigarette products on the market. In this way, any “hard” to visually “sharp” edges of the produced/emitted light from the light source 206 are reduced by the light diffusion plastic. Alternatively, or additionally, the above-described feathering-effect may also be enhanced by varying the radius of curvature the body 200 of the device 102 (also referred to as a “body radius drop-off”).

In one example, the diffusion plastic is formed from an electrically and thermally insulating material. In this way, the diffusion plastic may function as a protective mask in front of the at least one light source 206 in order to avoid hot spots forming on the outer surface of the device's body 200. This advantageously prevents the user from burning their hands, or simply avoids the device's body becoming too warm, and thereby becoming uncomfortable to hold for long periods of time, for example.

In one embodiment of the device 102, the movement sensor 117 of the device 102 includes an accelerometer 117, and the trigger input 105 is in the form of one or more taps on the device 102 by a user. The accelerometer 117 may be configured to detect movement or motion of the device 102 when the device 102 is moved in any way, and typically when the device 102 is either tapped, shaken, touched, or knocked by the user in any combination. For example, the user may tap anywhere on the surface of the body 200 of the device 102, such as the top surface 201 and/or the rear surface 202 in any combination. In one example embodiment, the user is able to trigger an input 105, in order to activate the previously discussed “burn down” mode 113, by tapping any surface of the body 200 of the device 102 twice. As the skilled person will appreciate, the device 102 may alternatively be tapped any number of times in order to trigger an input 105. Alternatively, or additionally, the device 102 may be knocked or tapped at, or near to, the lower end 110 of the device 102 in order to trigger an input 105, such as gently tapping or knocking the lower end 110 against a flattened surface, for example.

It is well known that users of conventional cigarettes (at least) are often required to “tamp” or “pack” the cigarette in order to physically condense the tobacco contained within the (typically) paper cylindrical body of that cigarette. As such, many smokers are accustomed to “tamping” or “packing” each cigarette in this way before using them (e.g., lighting the tip of the cigarette, often refer to as “lighting up”). This behavior is therefore instinctive to many smokers and often done out of habit. In this way, by having a trigger input 105 to the device 102 in the form of an accelerometer 117, the device 102 is able to detect user-related motion typically associated with conventional smoking behavior, namely “tamping” or “packing” (e.g., tapping, shaking, knocking, etc.) of conventional cigarettes. The device 102 therefore advantageously responds to a trigger input 105 provided by a user that would otherwise only be associated with conventional cigarettes.

In another embodiment, the device 102 comprises a vibrating means (not shown in the figures) wherein the processor 120 is configured to cause the vibrating means to vibrate in response to receiving the trigger signal 105, thereby generating audible or haptic feedback. In one embodiment, the vibrating means is in the form of a haptic motor for vibrating the device 102 and/or producing an audible noise for the user to hear. In an example embodiment, the haptic motor (also known as a haptic feedback generation unit) is in the form of an electric motor and a weight mounted eccentrically on a shaft of the electric motor (also not shown in the figures).

Alternatively, or additionally, the vibrating means may be in the form of a buzzer or alarm (not shown in the figures). Advantageously, the vibrating means allows the user to hear responses from the device when the user is located a certain distance away from the proximity of the device 102, such as in the form of an audible noise. To illustrate examples, the audible noise may be formed when the device 102 vibrates against a solid surface (e.g., on a bedside table), or the device 102 sounds a buzzer/alarm out loud. A prospective user may wish to feel physical responses, such as vibrations, from the device 102 additionally, or alternatively to, receiving a visual feedback from the device 102. Advantageously, the vibrating means therefore provides a means for the user to feel responses from the device 102 (e.g., in response to receiving a trigger signal 107). This is particularly advantageous for the user if the device 102 is not directly visible to the user (e.g., if the device is in the user's pocket).

In another embodiment of the device 102, the at least one light source 206 is configured to display a flashing light signal and/or display a solid light signal to the user for a predetermined time period. If the at least one light source 206 is a plurality of light sources, such as an array of LEDs, or an array of light bulbs, then the entire array is configured to display a flashing light signal and/or display a solid light signal for a predetermined time period. In this way, the array of LEDs or light bulbs may be arranged along the body 200 of the device 102 in order to collectively form an “illumination region”. Alternatively, if the at least one light source 206 is a single light source 206, such as a single bulb or LED strip, then single light source similarly forms the “illumination region”. In this way, the illumination region is perceived by the user to homogenously illuminated region of the device 102. The appearance of the illuminated region may be further enhanced by the incorporation of the light diffusion plastic (as previously discussed), which may further act to diffuse the light in a homogenous manner. The illumination regions of the device 102 are in the form of the illuminated light pipes 207 shown in both FIG. 13 and FIG. 14.

Advantageously, by using solid light signals and/or flashing lights signals, the device may be able to communicate, or visibly convey, different types of alerts, notifications, and/or or messages to the user in a visual way. Furthermore, a flashing light signal may mimic the flickering and/or glowing embers typically associated with conventional tobacco-burning products. This way, the user of the device may further be provided with an e-smoking experience which more closely mimics the behavior of a conventional cigarette.

In another embodiment of the device 102, the at least one light source 206 is further configured to vary an amount of an illumination region 207 which is illuminated, or a brightness level, based on the available usage of the device 102. As previously discussed, the illumination region 207 may be formed along a length of the body 200 of the device 102.

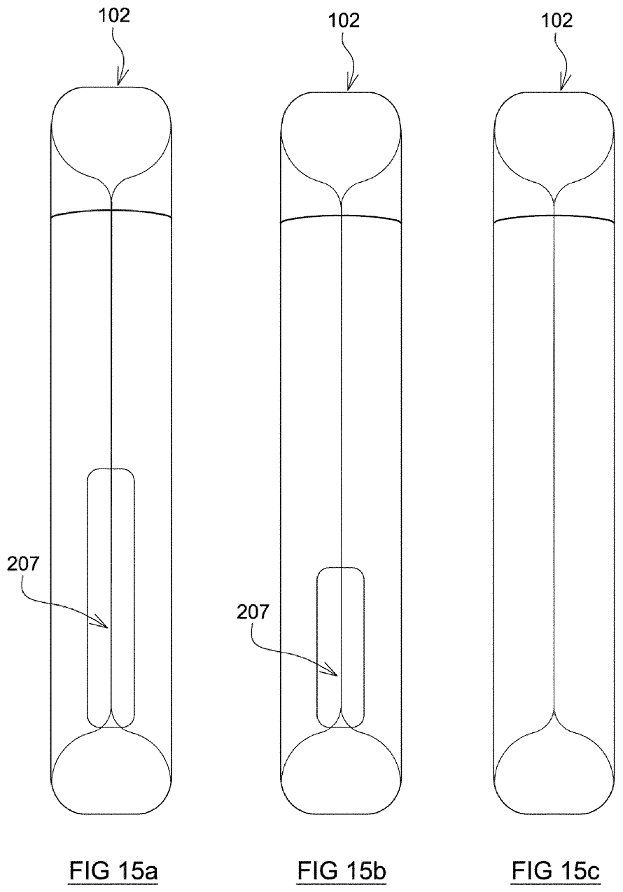

FIG. 15 illustrates three separate side-on views of the device 102 according to the same embodiment of the device 102 in the present application. Similar to the embodiments shown in FIG. 13 and FIG. 14, FIG. 15a shows that the illumination region 207 located along a full longitudinal length of the device 102. FIG. 15b further shows the illumination region 207 located along the partial longitudinal length of the device 102. In contrast to the other figures, FIG. 15c further shows a total absence of an illumination region 207 on the device 102.

When the illumination region 207 is illuminated along the full longitudinal length of the device 102 (e.g., as shown in FIG. 15a), it visibly resembles the length of an un-lit (i.e., un-used) conventional cigarette to the user. Similarly, when the illumination region 207 is illuminated along the partial length of the device 102 (e.g., as shown in FIG. 15b), it instead visibly resembles the length of a lit cigarette (e.g., a cigarette currently being smoked) to the user. When there is a total absence of an illumination region 207 being shown by the device 102 (e.g., as shown in FIG. 15c), the user is informed that the device 102 is currently not in use (e.g., the device 102 may be turned off), or at least not triggered to perform the “burn down” mode 113 operation. In other words, device 102 is advantageously configured to allow the illumination region 207 to visibly resemble a conventional cigarette which is progressively “burning down” towards the opposite end (i.e., undergoing the “burn down” mode 113 operation).

In one embodiment of the device 102, the available usage of the device is defined in terms of a predetermined remaining number of puffs, or a predetermined remaining amount of smoking time. Preferably, a predetermined remaining number of puffs, or a predetermined remaining amount of smoking time may refer to a fixed (e.g., user pre-set) value or amount, and therefore may not be dependent on any other operating component of the device 102, such the amount of battery, power source, or power source capacity available, etc. In one embodiment, the user may be able to configure the device 102 to provide a predetermined remaining number of puffs available for inhalation by the user, or a predetermined remaining amount of smoking time available to the user.

In yet another example embodiment, the user is able to define these predetermined values by adjusting the operational settings of the device 102. This may be done via an application (or “app”), that may be installed on a user's personal device (e.g., a smartphone). The personal device may be configured to connect with device 102 via a wireless connection (e.g., via Bluetooth, Wi-Fi, etc.) or via a wired connection (e.g., via a direct connection-cable, a USB port connection etc.). In one embodiment, the application may include a graphical user interface (or GUI) which allows the user to input or select the remaining number of puffs available for inhalation by that user, and/or the remaining amount of smoking time available to that user. This advantageously allows the user to better customize the device's e-smoking experience, particularly if the user is accustomed to smoking conventional cigarettes which typically may a predetermined (e.g., a finite number) of inhalation puffs in them, or have a predetermined smoking time associated with them.

In a further embodiment of the device 102, the at least one light source 206 is configured to display a full brightness level in order to indicate: i) a full number of inhalation puffs available, or a full time duration of each inhalation puff available. The at least one light source 206 s further configured to display a partial brightness level in order to indicate: ii) a partial number of inhalation puffs available, or a partial time duration of each inhalation puff available. The at least one light source 206 is then further configured to display a zero-brightness level in order to indicate: iii) a zero number of inhalation puffs available, or a zero time duration of each inhalation puff available. To illustrate the operation of the device 102 by way of an example, the brightness level of the at least one light source (e.g., an array of LEDs) may be varied from full brightness (i.e., a 100% brightness level), through a partial brightness (e.g., a 50% brightness level), to a zero brightness (i.e., a 0% brightness level). In other words, the device 102 may be able to vary the brightness level being displayed to the user depending on whether there is either a full, partial, or zero number of inhalation puffs available to that user. Similarly, the device 102 may be able to vary the brightness level being displayed to the user in depending on whether there is either a full, partial, or zero time of duration of each inhalation puff available to that user.

In another example embodiment, the at least one light source 206 may take the form of the previously discussed light pipe 207. As shown in FIG. 15, the light pipe 207 may be incremented (e.g., moved up or down) in accordance the number of inhalation puffs available, or a full time duration of each inhalation puff available. To illustrate the operation of the device 102 by way of an example, the longitudinal length of light pipe 207 may be varied from full length (i.e., as shown in FIG. 15a), through a partial length (e.g., as shown in FIG. 15b), to an absence of any length being shown at all (i.e., as shown in FIG. 15c). In other words, the device 102 may be able to increment or vary the overall length of the light pipe 207 being displayed to the user depending on whether there is either a full, partial, or zero number of inhalation puffs available to that user.

Advantageously, varying either the brightness and/or the longitudinal length of the light pipe 207 can visually indicate two different values (or device 102 “parameters”) to the user at any one time and provide the user with a visual indication of any ‘on-the-fly’ changes to these two different values (or “parameters”) progressively over time, or during use of the device 102. This therefore provides the user with an easy-to-read way of monitoring the progress of their e-smoking session.

In one embodiment, the processor 120 is configured to determine an amount of power remaining in the power supply, and the visual feedback element is further configured to indicate the remaining amount of power.

In one embodiment, the visual feedback element is configured to vary a color of the illumination region based on the amount of power remaining in the power supply.

In an example, the visual feedback element may be further configured to indicate an amount of remaining amount of power left in the power supply of the device 102 to the user by varying the color, brightness, and/or intensity of the light emitted by the at least one light source 206. Advantageously this further allows the device to visually indicate a battery power level to the user ‘on-the-fly’. Again, the device 102 therefore provides the user with an easy-to-read method of monitoring the battery power levels available to the device (e.g., via the battery), so that they may be able to time-manage their e-smoking sessions more effectively. To illustrate an example scenario; a user may determine to not spend a lot of time using the device 102 for an e-smoking session it if the power supply is indicated to be low, whereas they may determine to spend more time using the device if the opposite is true (i.e., the power supply is indicated to be ample for use of the device 102).

In one embodiment the processor 120 is configured to compare the determined amount of power remaining in the power supply with a predetermined threshold, and if the amount of power remaining is greater than or equal to the threshold, the processor is configured to cause the visual feedback element to generate the illumination region in a first color, and if the amount of power remaining is less than the threshold, the processor is configured to cause the visual feedback element to generate the illumination region in a second color.

In one example, the predetermined thresholds may be pre-set percentage (%) values of the total power capacity available within the power supply (e.g., the battery). As the skilled person will appreciate, the threshold value is not limited to being a pre-set percentage (%) value of the total power capacity available, and may instead be any one of a pre-set voltage (V), current (I), or capacitance (C) value associated with the power supply or battery of the device 102, for example.

The choice of color generated in the illumination region of the device may advantageously indicate the criticality (or severity) of the current power level to the user. For example, a first color may be amber to indicate to the user that the current power level is at a non-critical level, whereas the second color may be red, indicating to the user that the current power level is a critically low level. As the skilled person will further appreciate, the visual feedback element may be illuminated in any colored light (e.g., white, blue, or green, etc.) and are not limited to the specific colors mentioned or illustrated in this application

In a preferred embodiment of the device 102, if the processor determines that the amount of power remaining is greater than or equal to a threshold value of 20% of the total power supply capacity available (i.e., the threshold is >20%), then the processor is configured to cause the visual feedback element 103 (e.g., an array of LEDs) to illuminate the illumination region in amber colored light. In contrast, if the processor determines that the amount of power remaining is less than or equal to a threshold value of 20% of the total power supply capacity available (i.e., the threshold is 20%), then the processor is configured to cause the visual feedback element to illuminate the illumination region in red colored light. As the skilled person will appreciate, the specific threshold value is not limited to being either above or below a 20% value of the total power capacity available (as given in the preferred embodiment), and may instead be any pre-set percentage value of the total power capacity available.

In a further embodiment of the device 102, the processor 120 is configured to operate the haptic motor or buzzer in response to a determination that either: some (e.g., 50%) or all (i.e., 100%) of the total battery level has been used up. Preferably the haptic motor is configured to vibrate the device with one vibration at the 50% mark, in order to indicate a progression of the battery usage to the user. Additionally, the visual feedback element 103 may also flash any number of times.

In another preferred embodiment of the device 102, a user is able to enable to ensure that device 102 enters a preselected mode of operation 113, such as the burn down mode of operation 113 (as previously described). The burn down mode of operation 113 enables the user to activate and/or a select a predetermined e-smoking session (sometimes referred to as a “sessioning” the device 102). For example, the predetermined e-smoking session may be a customizable session, as defined by the specific mode of operation 113. The user customizes the session so that the device 102 is configured to provide a predetermined remaining number of puffs available for inhalation, and/or a predetermined remaining amount of smoking time available to the user. Activation of the burn down mode of operation 113 is triggered by a trigger input 105 in the form of a user tapping 105 anywhere on the body 200 of the device 102. The movement sensor 117, in the form of an accelerometer 117 detects the tapping 105 and is then configured to output a trigger signal 107 to the processor 120. In response to receiving the trigger signal 107, the processor 120 is configured to cause the device 102 to enter the customized burn down mode 113.

Once the device 102 is operating in burn down mode 113, the visual feedback element 103, in the form of an amber colored light pipe 207 is illuminated at a full longitudinal length (as shown in FIG. 10A), indicating a full (i.e., 100%) amount of puffs available to the user.

An e-smoking session may comprise a total of 10 puffs for inhalation by the user. In an example use of the device 102, once the user begins to smoke the device 102 (e.g., inhales any number of puffs), in response to any number of puffs taken by the user, the processor 120 determines how many puffs are left and decrements the amber colored light pipe 207 accordingly. For example, if the user takes 5 puffs out of a total of available 10 puffs, the processor 120 determines that there are 5 puffs left. The processor 120 subsequently adjusts (or decrements) the illumination of the amber colored light pipe 207 accordingly, so that it reduces in length and is only illuminated along a partial longitudinal length (as shown in FIG. 15b), indicating that 50% (i.e., half) of the (initial) total number of puffs have been used up, and that 50% of the (initial) total puffs are still available for inhalation by the user. Decrementing of the light pipe 207 may be adjusted in a discrete way (e.g., decrementing a set amount of length at a time), or instead adjusted in a continuous way. After the user continues to smoke the remaining 5 puffs available, the processor 120 subsequently determines that there a no puffs available (i.e., all the available puffs have been used up). At this point, the processor 120 adjusts the illumination of the amber colored light pipe 207 accordingly, so that it the light pipe 207 reduces in length to zero, and stops all illumination along the longitudinal length (as shown in FIG. 15c), indicating that all (i.e., 100%) of the (initial) total number of puffs have been used up, and that zero (i.e., 0%) of the (initial) total puffs are now available for inhalation by the user.

Alternatively, or additionally, when the amber colored light pipe 207 is illuminated at a full longitudinal length (as also shown in FIG. 15a), it indicates a full (i.e., 100%) remaining amount of smoking time available to the user.

An e-smoking session may be allocated to last 10 minutes in total. In an example use of the device 102, once the user begins to smoke the device 102 (e.g., uses the device 102 for some time). In response to the amount of smoking time already taken up or used by the user, the processor 120 subsequently determines how much allocated smoking is left and decrements the amber colored light pipe 207 accordingly. For example, if the user smokes for 5 minutes as part of an e-smoking session that is allocated to last 10 minutes in total, the processor 120 determines that there are 5 minutes of allocated smoking time left. The processor 120 subsequently adjusts (or decrements) the illumination of the amber colored light pipe 207 accordingly, so that it reduces in length and is only illuminated along a partial longitudinal length (as shown in FIG. 15b), indicating that 50% (i.e., half) of the (initial) allocated smoking time has already been used up, and that 50% of the (initial) allocated smoking time is still available to the user. In the same way as previously discussed, decrementing of the light pipe 207 may be adjusted in a discrete way, or adjusted in a continuous way. After the user continues to smoke for the remaining 5 minutes, the processor 120 subsequently determines that there is no allocated smoking time available (i.e., the total allocated smoking time has been fully used up). At this point, the processor 120 adjusts the illumination of the amber colored light pipe 207 accordingly, so that it the light pipe 207 reduces in length to zero. After which, the processor 120 stops all illumination along the longitudinal length (as shown in FIG. 15c), indicating that all (i.e., 100%) of the allocated smoking time has been used up, and that zero (i.e., 0%) of the allocated smoking time are now available for inhalation by the user.

In a further embodiment of the device 102, the processor 120 is configured to operate the haptic motor or buzzer in response to a determination that either: i) some (e.g., 50%) or all (i.e., 100%) of the total number of puffs have been used up, or that ii) some (e.g., 50%) or all (i.e., 100%) of the allocated smoking time has been used up. Preferably the haptic motor is configured to vibrate the device with two vibrations at the 50% mark, in order to indicate a progression of usage to the user.

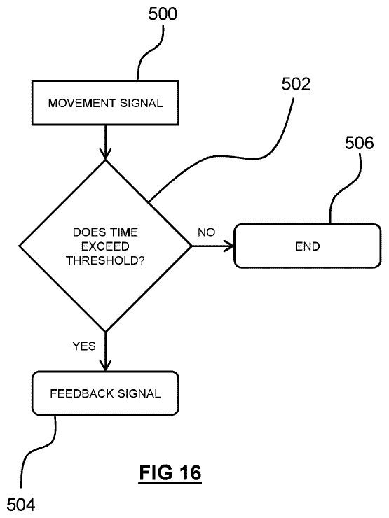

FIG. 16 is a flow chart illustrating general operation of a controller of a smoking substitute device (such that described above). At block 500 the controller receives a movement signal from a movement sensor of the device. The movement signal is indicative of movement of the device and may, for example, be a general movement of the device, or a specific movement (such as that experience in response to, e.g., 3 taps on the device by a user). In response to receipt of the movement signal, at block 502, the controller determines whether the time period since a previous user interaction exceeds a threshold time period (stored in a memory of the device). If the time period does exceed the threshold, then that is indicative that the device is not being used by a user.

If the controller determines (at block 502) that time period exceeds the threshold, then at block 504, the controller transmits a feedback signal to a user feedback element (including, e.g., haptic feedback generators, LEDs and/or a display screen) of the device. In some cases, the feedback signal may be based on or representative of an operating characteristic (e.g., battery charge) of the device.

On the other hand, if the controller determines that the time period does not exceed the threshold, as shown at block 506, the controller may not provide a feedback signal (and may simply end the current sequence).

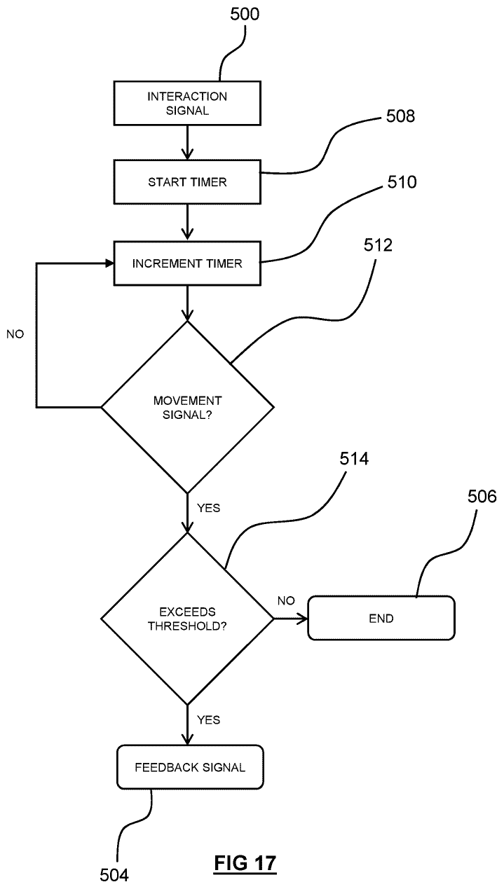

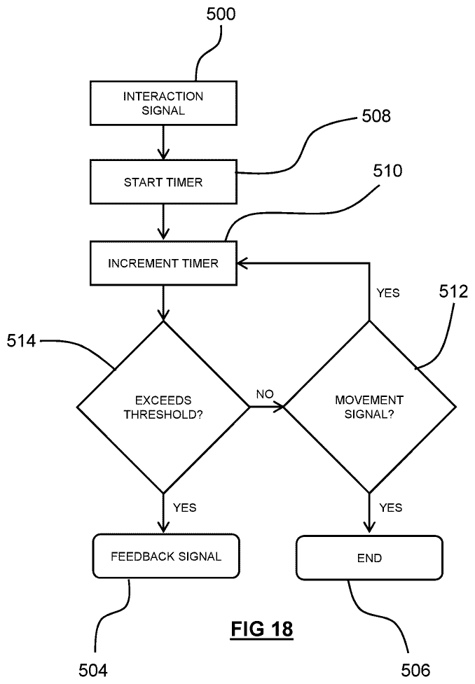

FIG. 17 and FIG. 18 illustrate two different ways in which the controller of the device may assess whether the time period since the previous user interaction (represented by an interaction signal) has exceeded a predetermined threshold time period.

In FIG. 17, at block 500 the controller receives an interaction signal from a sensor of the device (i.e., indicative of interaction with the device). The interaction may be an inhalation, movement and/or connection to an external power source. In response to receipt of the interaction signal, at block 508, the controller starts a timer and, at block 510, increments the timer. Subsequently, at block 512, the controller checks whether a movement signal has been received. The movement signal is received from a movement sensor of the device. If no movement signal has been received, then the controller increments the timer and checks again whether a movement signal has been received. This process continues (in a repeated manner) until the controller receives a movement signal.

When the controller does receive the movement signal, it compares, at block 514, the value of the timer (being indicative of the time period since the interaction signal) with a predetermined threshold value. If the value of the timer is greater than the threshold value then the controller deems the device to be in an idle state and proceeds, at block 504, by transmitting a feedback signal to the user feedback element of the device. On the other hand, if the value does not exceed the threshold value, then at block 506, the controller ends the sequence.

A variation of this control method is shown in FIG. 18. In this variation, the controller again receives an interaction signal (from a sensor of the device) at block 500, starts a timer at block 508 and increments the timer at block 510. However, in this variation, at each increment of the timer, the controller checks (at block 514) whether the increment of the timer has caused the value of the timer to exceed a predetermined threshold value (stored in a memory of the device). If the timer value does not exceed the threshold value, then the controller, at block 512, checks whether a movement signal has been received. If a movement signal is received then the controller ends the sequence at block 506. If, on the other hand, a movement signal has not been received, then the controller returns to block 510 and once again increments the timer.

If, at block 514, the controller determines that the incremented timer value exceeds the threshold, at block 516, the controller stores (in a memory of the device) an indication that the device is in an idle state. Although not shown, when a movement signal is subsequently received, the controller checks the memory for the stored state of the device. If the stored state is an idle state, then the controller transmits a feedback signal to a user feedback element of the device (i.e., for indication/communication to a user by the user feedback element).

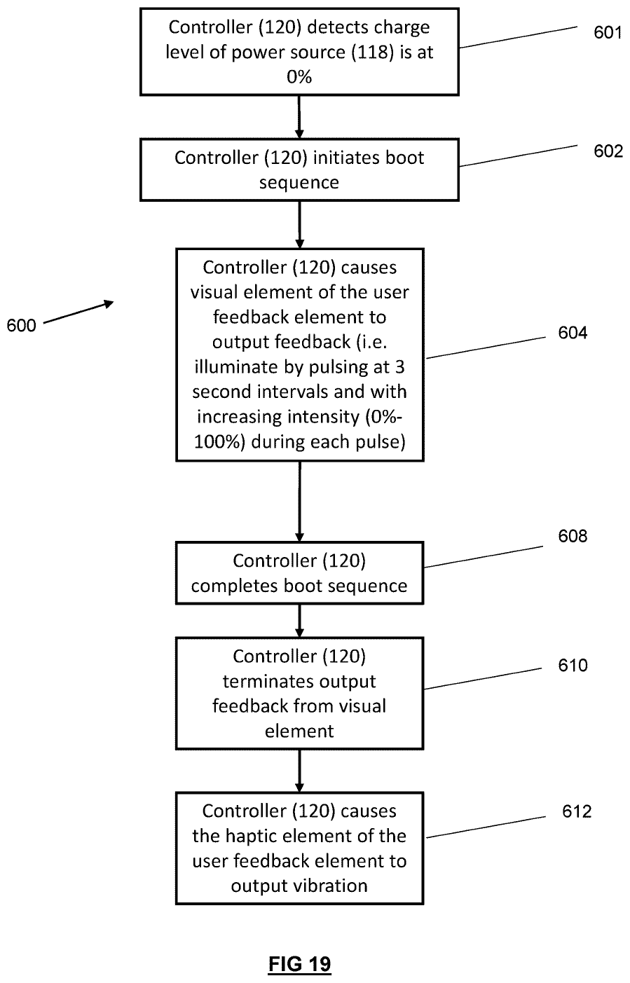

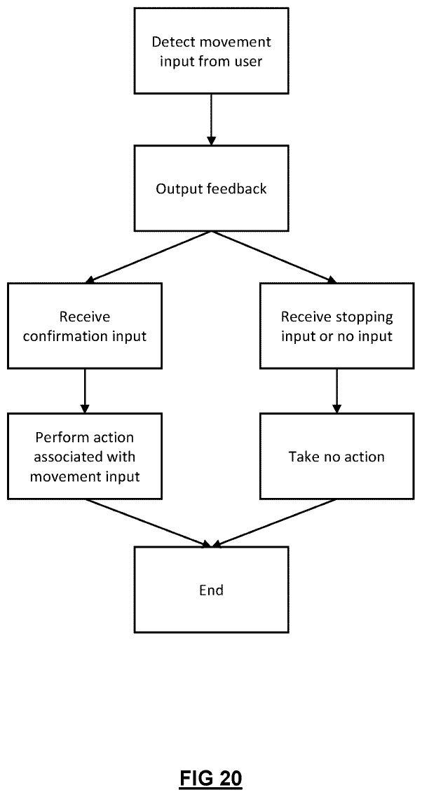

FIG. 19 shows a diagram of the steps performed by the device 102 of the eighth aspect as the boot sequence is performed.

The controller 120 is configured to initiate the boot sequence. The controller 120 is configured to initiate the boot sequence when the power source 118 reaches 0% charge level and is connected to an electrical power supply.

The device 102 includes a user feedback element which includes a visual feedback element and a haptic feedback generation unit. The visual feedback element includes at least one LED. The controller 120 is configured to cause the visual feedback element to illuminate when the boot sequence initiates. The visual feedback element includes at least one blue LED.

The controller 120 is configured to cause the visual feedback element to illuminate by pulsing at 3 second intervals and to illuminate with increasing intensity from 0% to 100% intensity at each pulse.

The controller 120 is configured to carry out the boot sequence and cause the visual feedback element to continue pulsing at 3 second intervals during the boot sequence.

The controller 120 is configured to complete the boot sequence and terminate the output feedback from the visual feedback element (i.e., the controller 120 is configured to cause the visual feedback element to stop illuminating).

As the boot sequence completes, the controller 120 is configured to cause the haptic feedback generation unit to vibrate. The haptic feedback generation unit is configured to emit a vibration pulse/burst as the boot sequence completes.

The controller 120 detects the charge level of the power source 118 (step 601). As the charge level of the power source 118 reaches 0% charge level and the power source 118 is connected to an electrical power supply, the controller 120 performs the boot sequence. In particular, at step 602, the controller 120 initiates the boot sequence. As the controller 120 initiates the boot sequence the controller causes the visual feedback element to illuminate. In particular, the controller causes the visual feedback element to illuminate by pulsing at 3 second intervals and with increasing intensity (0-100%) at each pulse (step 604).

At step 608, the controller 120 completes the boot up sequence. As the controller completes the boot sequence, the controller 120 terminates illumination of the visual feedback element (step 610).

As the controller completes the boot sequence, the controller 120 also causes the haptic feedback generation unit to vibrate with a single pulsed vibration (step 612).

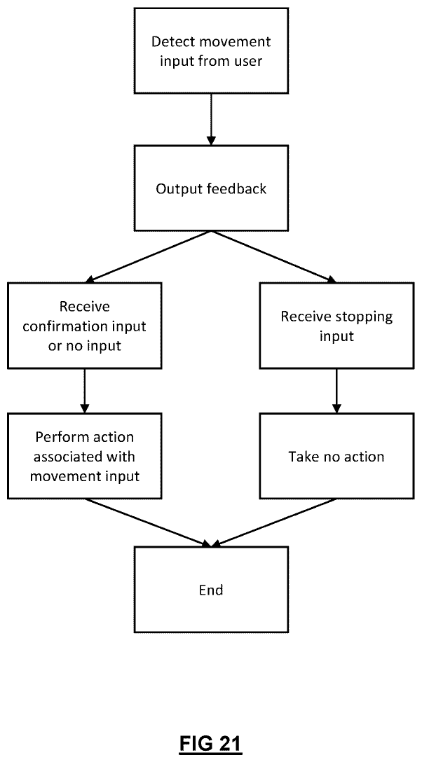

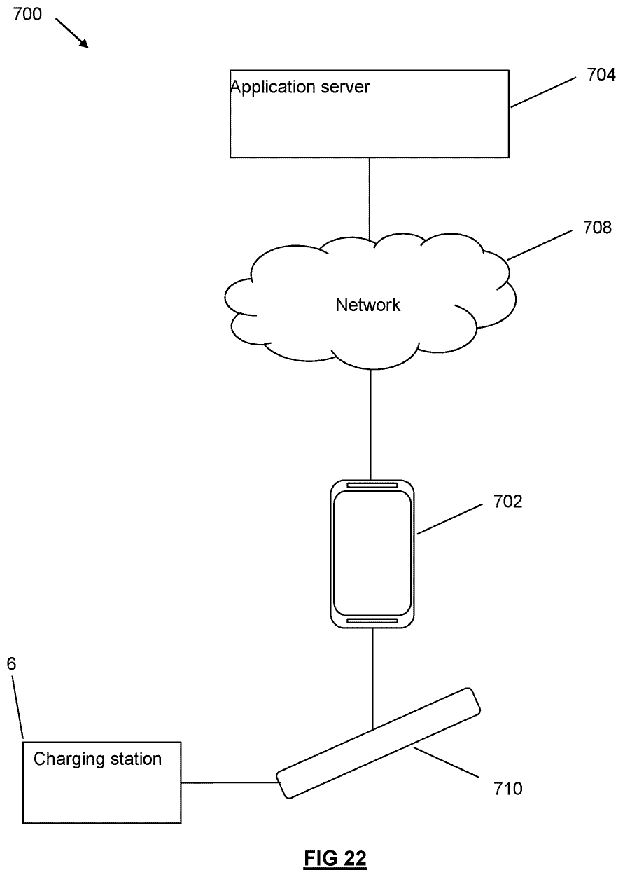

FIGS. 20 and 21 show alternative methods which may be performed by the aerosol delivery device of the ninth aspect. In FIG. 20, a movement input is received by the device, and corresponding feedback, preferably mimicking the input is output. Then, if a confirmation input is received, the device goes ahead and performs the action corresponding to the movement input. However, if no confirmation input is received, or a stopping input is received, then no action is taken. In other words, in the method of FIG. 20, the action performed if and only if a confirmation input is received. FIG. 21 operates the other way round. Here, the default position is for the action to be performed, and only in the even that a stopping input is received will the action not be performed.

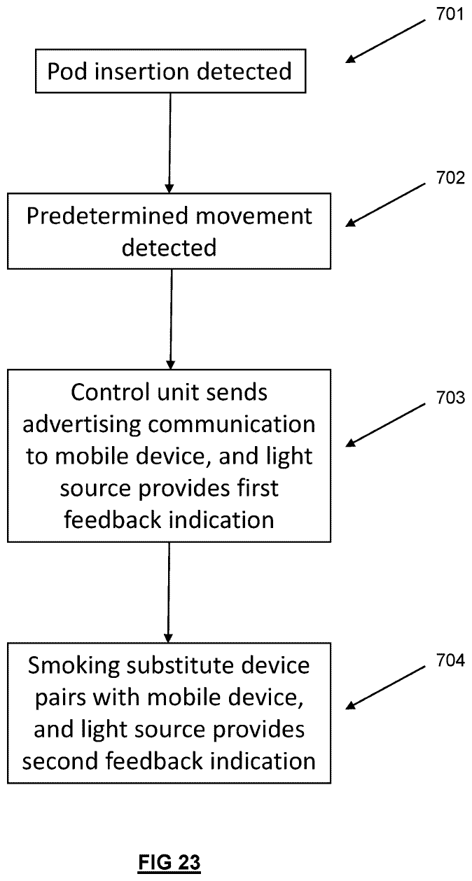

FIG. 22 shows an example system 300 for managing a smoking substitute device 310, such as smoking substitute device 100 described with reference to the previous figures. The system 300 as shown in FIG. 22 includes a mobile device 702, an application server 704, an optional charging station 706, as well as the smoking substitute device 710.

The smoking substitute device 710 is configured to communicate wirelessly, e.g., via Bluetooth™, with an application (or “app”) installed on the mobile device 702, e.g., via a suitable wireless interface (not shown) on the mobile device 702. The mobile device 702 may be a mobile phone, for example. The application on the mobile phone is configured to communicate with the application server 704, via a network 708. The application server 704 may utilize cloud storage, for example.

The network 708 may include a cellular network and/or the internet.

In other examples, the smoking substitute device 710 may be configured to communicate with the application server 704 via a connection that does not involve the mobile device 702, e.g., via a narrowband internet of things (“NB-IoT”) connection.

A skilled person would readily appreciate that the mobile device 702 may be configured to communicate via the network 708 according to various communication channels, preferably a wireless communication channel such as via a cellular network (e.g., according to a standard protocol, such as 3G or 4G) or via a WIFI network.

The app installed on the mobile device and the application server 704 may be configured to assist a user with their smoking substitute device 710, based on information communicated between the smoking substitute device 710 and the app and/or information communicated between the app and the application server 704.

The charging station 706 (if present) may be configured to charge (and optionally communicate with) the smoking substitute device 710, via a charging port on the smoking substitute device 710. The charging port on the smoking substitute device 710 may be a USB port, for example, which may allow the smoking substitute device to be charged by any USB-compatible device capable of delivering power to the smoking substitute device 710 via a suitable USB cable (in this case the USB-compatible device would be acting as the charging station 706). Alternatively, the charging station could be a docking station specifically configured to dock with the smoking substitute device 710 and charge the smoking substitute device 710 via the charging port on the smoking substitute device 710.

FIG. 23 is a flowchart of operations which may be performed by the smoking substitute device 710 of the tenth aspect. Specifically, the smoking substitute device may follow the operations of FIG. 23 when a user wishes to pair the smoking substitute device with a mobile device.

At step 701, the controller 120 in the device 102 of the smoking substitute device 100 determines that a consumable component 104 (e.g., pod) has been inserted into the device 102 of the smoking substitute device 100. The controller 120 may store this information in memory 122.

At step 702, a predetermined movement of the smoking substitute device 110 is detected by an accelerometer in the device 102. The predetermined movement may be a predetermined tapping sequence performed within a predetermined “tap sequence” length of time, such as continuous tapping for 5 or more seconds. The predetermined movement may be stored in memory 122, and the controller may compare the detected movement of the smoking substitute device 110 with the predetermined movement stored in memory 122 to determine whether the detected movement is equivalent to the stored predetermined movement.

The controller may continually monitor for a consumable component insertion and for the predetermined movement.

If the controller 120 detects a consumable component insertion (i.e., step 701), followed by the predetermined movement (i.e., step 702) within a predetermined period of time (e.g., 10 seconds), the controller 120 determines that the user wishes to pair the smoking substitute device with the mobile device and the method moves to step 703.

If step 702 is not performed within the predetermined period of time from step 701, the method does not proceed to step 703. This prevents the user accidently instructing the pairing of the smoking substitute device with a mobile device, as there is a two-step authentication process.

At step 703, the controller 102 determines that the user wishes to pair the smoking substitute device 100 with the mobile device (such as mobile device 702 in FIG. 22), and sends an advertising wireless communication to the mobile device requesting pairing of the smoking substitute device and the mobile device.

Also in step 703, and at the same time as sending the advertising wireless communication, the smoking substitute device provides feedback to the user that the smoking substitute device has understood the user's instruction to pair with the mobile device, and is requesting the pairing of the two devices.

Accordingly, in the example shown in FIG. 23, the light 116 in the device 102 provides a first feedback visual indication to the user. For example, the light 116 may emit continuous white light.

If the mobile device 702 permits communication with the smoking substitute device 710, a wireless communication link is enabled between the two devices (step 704). Also in step 704, when the wireless communication link is enabled, the second feedback indication is provided by the light 116. Specifically, the light 116 stops emitting continuous white light (the first feedback indication) and instead emits three flashes of white light. This second feedback indication informs the user that the smoking substitute device is paired with the mobile device.

While exemplary embodiments have been described above, many equivalent modifications and variations will be apparent to those skilled in the art when given this disclosure. Accordingly, the exemplary embodiments set forth above are considered to be illustrative and not limiting.

Throughout this specification, including the claims which follow, unless the context requires otherwise, the words “have”, “comprise”, and “include”, and variations such as “having”, “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means, for example, +/−10%.

The words “preferred” and “preferably” are used herein refer to embodiments that may provide certain benefits under some circumstances. It is to be appreciated, however, that other embodiments may also be preferred under the same or different circumstances. The recitation of one or more preferred embodiments therefore does not mean or imply that other embodiments are not useful, and is not intended to exclude other embodiments from the scope of the disclosure, or from the scope of the claims.

### ILLUSTRATIVE EMBODIMENTS

Preferred embodiments are as described in the following numbered paragraphs:

1. An aerosol delivery device, comprising:
an inhalation sensor, configured to detect a user inhaling through a mouthpiece of the aerosol delivery device;
a visual feedback element, configured to provide visual feedback to the user; and
a controller, connected to the inhalation sensor and visual feedback element, and configured to gradually change the intensity of the visual feedback element, when the inhalation sensor detects a user inhalation, over a duration of the user inhalation.

2. The aerosol delivery device of paragraph 1, wherein the change of the intensity of the visual feedback element is based on an intensity and/or duration profile of the inhalation as detected by the inhalation sensor.

3. The aerosol delivery device of paragraph 2, wherein the change of the intensity of the visual feedback element is proportional to the intensity and/or duration profile of the inhalation as detected by the inhalation sensor.

4. The aerosol delivery device of paragraph 1 or 2, wherein the change of the intensity of the visual feedback element follows a predefined intensity profile.

5. The aerosol delivery device of any preceding paragraph, wherein the controller is further configured to terminate visual feedback from the visual feedback element when it detects via the inhalation sensor that inhalation has ceased.

6. The aerosol delivery device of any preceding paragraph, wherein the controller is further configured to detect a charge level of a battery in the aerosol delivery device, and to vary a parameter of the visual feedback element based on the detected charge level.

7. The aerosol delivery device of paragraph 6, wherein the controller is configured to vary a color of the visual feedback element based on the detected charge level being below a predetermined threshold charge level.

8. The aerosol delivery device of any preceding paragraph, wherein the visual feedback element comprises:
an illumination region of a device body of the aerosol delivery device; and
a source of light, contained within the device body, the illumination region being configured such that light provided by the source of light passes through the illumination region of the device body;
wherein the controller is configured to gradually change the intensity of the source of light.

9. The aerosol delivery device of paragraph 8, wherein the source of light is an array of light emitting diodes.

10. The aerosol delivery device of paragraph 8 or paragraph 9, wherein the illumination region of the device body is made from a diffusing material, such that the light passing through the illumination region from the source of light is diffused.

11. The aerosol delivery device of any of paragraphs 8-10, wherein the device body includes a shell having a first area with a first thickness, and a second area with a second thickness, the first area including the illumination region and the first thickness being thinner than the second thickness.

12. The aerosol delivery device of any preceding paragraph, wherein the aerosol delivery device has a mandorla-shaped cross-section.

13. An aerosol delivery system comprising a device according to any one of the preceding paragraphs and a component comprising an aerosol precursor.

14. An aerosol delivery device for use with a consumable component containing an aerosol precursor, the aerosol delivery device comprising:
a controller;
an input means;
a visual feedback element;
wherein:
the input means is configured to detect a trigger input from a user, and to output a trigger signal to the processor;
in response to receiving the trigger signal, the controller is configured to initiate a preselected mode of operation, associated with a total available usage;
when the device is operating in the preselected mode, the visual feedback element is configured to indicate a remaining available usage of the device to the user.

15. The aerosol delivery device of paragraph 14; wherein the visual feedback element comprises one or more light sources.

16. The aerosol delivery device of paragraph 14 or 15, wherein the total available usage of the device is defined in terms of a predetermined total number of puffs, or a predetermined total amount of smoking time.

17. The aerosol delivery device of paragraph 16, wherein the predetermined total number of puffs or the predetermined total smoking time is configurable by a user.

18. The aerosol delivery device of paragraph 16 or paragraph 17, wherein:
in response to a first user input, the input means may be configured to output a first trigger signal to the controller, which causes the device to initiate a first preselected mode of operation, and
in response to a second user input, the input means may be configured to output a second trigger signal to the controller, which causes the device to initiate a second preselected mode of operation, and
the predetermined total available usage associated with the first preselected mode of operation is different from the predetermined available usage associated with the second preselected mode of operation.

19. The aerosol delivery device of any one of paragraphs 14 to 18, wherein the input means includes a movement sensor.

20. The aerosol delivery device of paragraph 19, wherein the movement sensor includes an accelerometer configured to detect a trigger input in the form of an acceleration, a force, or an impulse applied to the device.

21. The aerosol delivery device of paragraph 20, wherein the accelerometer is configured to detect a trigger input in the form of one or more taps on the device by a user.

22. The aerosol delivery device of any one of paragraphs 14 to 21, further comprising a vibrating means, wherein the controller is configured to cause the vibrating means to vibrate in response to receiving the trigger signal, thereby generating audible or haptic feedback.

23. The aerosol delivery device of any one of paragraphs 15 to 22, wherein the body of the device includes an illumination region, configured to be illuminated by the one or more light sources.

24. The aerosol delivery device of paragraph 23, wherein the controller is configured to vary an amount of the illumination which is illuminated at a given time, based on the remaining available usage.

25. The aerosol delivery device of paragraph 24, wherein the visual feedback element includes a plurality of light sources, and the controller is configured to control the visual feedback element such that the proposition of the plurality of light sources which is illuminated corresponds to the remaining available usage.

26. The aerosol delivery device of any one of paragraphs 15 to 25, wherein the controller is configured to vary a brightness of the one or more light sources, based on the remaining available usage.

27. The aerosol delivery device of paragraph 26, wherein:
the one or more light sources is/are configured to display a full brightness level in order to indicate: a full number of inhalation puffs available, or a full time duration of each inhalation puff available;
the one or more light sources is/are configured to display a partial brightness level in order to indicate: a partial number of inhalation puffs available, or a partial time duration of each inhalation puff available; and
the one or more light sources is/are configured to display a zero-brightness level in order to indicate: a zero number of inhalation puffs available, or a zero time duration of each inhalation puff available.

28. An aerosol delivery device according to any one of paragraphs 14 to 27, wherein the controller is configured to determine an amount of power remaining in a power supply, and the visual feedback element is configured to indicate the remaining amount of power.

29. An aerosol delivery device according to paragraph 28, dependent on any of paragraphs 24 to 28, wherein the controller is configured to cause the visual feedback element to illuminate the illumination region in a different color, depending on the amount of power remaining.

30. An aerosol delivery system comprising an aerosol delivery device according to any one of paragraphs 14 to 29, and a component for containing an aerosol precursor.

31. A method of operation of an aerosol delivery device according to any one of paragraphs 14 to 29, or an aerosol delivery system according to paragraph 30, including the steps of:
detecting a trigger input from the user,
outputting the trigger signal to the controller;
in response to receiving the trigger signal, causing the device to enter a preselected mode of operation, associated with a predetermined total available usage;
and when the device is operating in the preselected mode, providing a visual feedback element to indicate a remaining available usage of the device to the user.

32. An aerosol delivery device, comprising:
a movement sensor configured to detect movement of the device and transmit movement signals indicative of movement of the device;
a user feedback element configured to receive feedback signals and provide feedback to a user in response to the feedback signals; and
a controller configured to receive a movement signal from the movement sensor, determine whether a time period since a previous user interaction with the device exceeds a threshold time period, and provide a feedback signal to the user feedback element if the time period exceeds the threshold time period.

33. An aerosol delivery device according to paragraph 32, wherein the previous user interaction is determined from a previous user interaction signal received by the controller.

34. An aerosol delivery device according to paragraph 33 wherein the interaction signal is indicative of the device being connected to an external power source and is received from a charging connector of the device.

35. An aerosol delivery device according to paragraph 34 wherein the interaction signal is indicative of inhalation from the device by a user and is received from an airflow sensor for detecting inhalation from the device by a user.

36. An aerosol delivery device according to paragraph 35 wherein the user interaction signal is indicative of movement of the device and is received from the movement sensor.

37. An aerosol delivery device according to paragraph 36 wherein the controller is configured to determine whether the interaction signal received from the movement sensor is indicative of a specific movement of the device stored in a memory of the device.

38. An aerosol delivery device according to paragraph 37 wherein the controller is configured to determine whether the specific movement of the device indicated by the interaction signal is indicative of a user tapping the device.

39. An aerosol delivery device according to any one of paragraphs 32 to 38 wherein the user feedback element comprises a haptic feedback generation unit and the feedback signal is received by the haptic feedback generation unit.

40. An aerosol delivery device according to any one of paragraphs 32 to 39 wherein the user feedback element comprises one or more LEDs and the feedback signal is received by the one or more LEDs.

41. An aerosol delivery device according to any one of paragraphs 32 to 40 wherein the controller is configured to determine a charge level of a battery of the device, and the feedback signal is indicative of the charge level, such that the charge level can be communicated to a user by the user feedback element.

42. An aerosol delivery system comprising a device according to any one of paragraphs 32 to 41 and a component comprising an aerosol precursor.

43. A method of controlling an aerosol delivery device, the method comprising:
detecting movement of the device;
upon detection of the movement, determining whether a time period since a previous user interaction with the device exceeds a threshold time period; and
providing a feedback signal to a user feedback element of the device for feedback to a user, if the time period exceeds the threshold period.

44. An aerosol delivery device, comprising:
a power source having a charge level;
a controller configured to perform a boot sequence when the charge level of the power source is below a predetermined level; and
a feedback unit
wherein the controller is configured to cause the feedback unit to output feedback:
   a) when the boot sequence initiates; and/or
   b) during the boot sequence; and/or
   c) when the boot sequence completes.

45. An aerosol delivery device according to paragraph 44, wherein the controller is configured to initiate the boot sequence when the power source is connected to an electrical power supply.

46. An aerosol delivery device according to paragraph 44 or 45, wherein the controller is configured to initiate the boot sequence when the power source is at a 0% charge level.

47. An aerosol delivery device according to paragraph 44, 45 or 46, wherein the feedback unit comprises a visual feedback element.

48. An aerosol delivery device according to paragraph 47, wherein the controller is configured to cause the visual feedback element to illuminate when the boot sequence initiates.

49. An aerosol delivery device according to paragraph 47 or 48, wherein the controller is configured to cause the visual feedback element to illuminate with a pulsed/flashing operation.

50. An aerosol delivery device according to paragraph 49, wherein the controller is configured to cause the visual feedback element to illuminate at 3 second intervals.

51. An aerosol delivery device according to paragraph 49 or 50, wherein the controller is configured to cause the visual feedback element to illuminate with an increasing intensity of 0-100% at each pulse.

52. An aerosol delivery device according to any one of paragraph 44 to 51, wherein the feedback unit comprises a haptic feedback generation unit.

53. An aerosol delivery device according to paragraph 52, wherein the controller is configured to cause the haptic feedback generation unit to vibrate when the boot sequence completes.

54. An aerosol delivery device according to paragraph 52 or 53, wherein the controller is configured to cause the haptic feedback generation unit to emit a single vibration pulse.

55. An aerosol delivery device according to any one of paragraphs 44 to 54, wherein the device is a smoking substitute device.

56. An aerosol delivery system comprising a device according to any one of paragraphs 44 to 55 and a component comprising an aerosol precursor.

57. A method of controlling an aerosol delivery device, the method including the steps of:
performing a boot sequence
causing a feedback unit to output feedback:
   a) when the boot sequence initiates; and/or
   b) during the boot sequence; and/or
   c) when the boot sequence completes.

58. A method of controlling an aerosol delivery device according to paragraph 57, including providing the feedback unit with a visual feedback element.

59. A method of controlling an aerosol delivery device according to paragraph 57 or 58, including causing the feedback element to illuminate when the boot sequence initiates.

60. A method of controlling an aerosol delivery device according to any one of paragraphs 57 to 59, including causing the visual feedback element to illuminate in a pulsed or flashing operation.

61. A method of controlling an aerosol delivery device according to any one of paragraphs 57 to 60, including providing the feedback unit with a haptic feedback generation unit.

62. A method of controlling an aerosol delivery device according to paragraph 61, including causing the haptic feedback generation unit to vibrate when the boot sequence completes.

63. A method of controlling an aerosol delivery device according to paragraph 61 or 62, including causing the haptic feedback generation unit to emit a single vibration pulse.

64. An aerosol delivery device including: a movement sensor; a controller; and a feedback unit, wherein: the movement sensor is configured to generate a movement detection signal in response to detection of movement of the device, the controller is configured to receive the movement detection signal, and to control operation of the device based on the movement detection signal; and the controller is further configured to cause the feedback unit to output feedback based on the movement detection signal.

65. An aerosol delivery device according to paragraph 64, wherein the feedback unit includes a vibrating element, and is thereby configured to provide either haptic or audible feedback.

66. An aerosol delivery device according to paragraph 64 or paragraph 65, wherein the controller is configured to cause the device to perform a first action in response to detection of a first movement input by the movement sensor, and the controller is configured to cause the device to perform a second action in response to detection of a second movement input by the movement sensor.

67. An aerosol delivery device according to paragraph 66, wherein the controller is configured to cause the device to perform a respective one of a plurality of predetermined actions in response to the detection of a corresponding movement input by the movement sensor.

68. An aerosol delivery device according to paragraph 66 or paragraph 67, wherein the device includes a memory storing a lookup table, the lookup table containing relationships between the movement inputs and the corresponding actions, and, in response to the detection of a predetermined movement input by the movement sensor, the controller is configured to search the lookup table for that movement input, thereby identifying the corresponding action to be performed by the device.

69. An aerosol delivery device according to any one of paragraphs 64 to 68, wherein the movement sensor includes an accelerometer.

70. An aerosol delivery device according to any one of paragraphs 66 to 69, wherein the predetermined movement inputs are in the form of a pattern of one or more taps of the device, characterized by a number of taps, and the time interval between successive taps.

71. An aerosol delivery device according to any one of paragraphs 66 to 70, wherein in response to the detection of a predetermined movement input by the movement sensor, the controller may be configured to cause the feedback unit to provide feedback corresponding to the predetermined movement input.

72. An aerosol delivery device according to paragraph 71, wherein the corresponding feedback is configured to mimic the predetermined movement input.

73. An aerosol delivery device according to paragraph 71 or paragraph 72, wherein the controller is configured to cause the device to perform the action corresponding to the movement input detected the movement sensor, only in response to a confirmation input received after the feedback unit has output the feedback corresponding to the received movement input.

74. An aerosol delivery device according to any one of paragraphs 71 to 73, wherein the controller is configured to cause the device to perform the action corresponding to the movement input detected the movement sensor, only in response to a confirmation input received within a predetermined amount of time after the feedback unit has output the feedback corresponding to the received movement input.

75. An aerosol delivery device according to any one of paragraphs 71 to 74, wherein in response to a stopping input received after the feedback has been output to a user, the controller is configured not to cause the device to perform the action corresponding to the predetermined movement input.

76. An aerosol delivery device according to paragraph 75, wherein the controller is configured not to cause the device to perform the action corresponding to the predetermined movement input only if the stopping input is received within a predetermined amount of time after the feedback unit has output the feedback corresponding to the received movement input.

77. An aerosol-delivery system comprising a device according to any one of paragraphs 64 to 76, and a component for containing an aerosol precursor.

78. A method of using the aerosol-delivery system of paragraph 77, the method comprising engaging the consumable component with an aerosol-delivery device having a power source so as to electrically connect the power source to the component.

79. An aerosol delivery device comprising a device body, the device body having a controller and a movement sensor configured to sense movement of the aerosol delivery device;
wherein the controller is configured to send an advertising communication to a mobile device when:
   a component is coupled to the device body; and
   a predetermined movement of the aerosol delivery device is detected using the movement sensor.

80. The aerosol delivery device of claim 79, wherein the controller is configured to send the advertising communication to the mobile device only when:
a component is coupled to the device body; and
the predetermined movement of the aerosol delivery device is detected using the movement sensor.

81. The aerosol delivery device of claim 79 or claim 80, wherein the controller is configured to send the advertising communication to the mobile device when a change in state of the aerosol delivery device is detected, the change in state being from a disassembled state in which a component is not coupled to the device body, to an assembled state in which a component is coupled to the device body.

82. The aerosol delivery device of claim 81, wherein the controller is configured to send the advertising communication to the mobile device when the change in state of the aerosol delivery device is detected before the predetermined movement of the aerosol delivery device is detected.

83. The aerosol delivery device of claim 81 or claim 82, wherein the controller is configured to send the advertising communication to the mobile device when the detection of the change in state of the aerosol delivery device and the detection of the predetermined movement of the aerosol delivery device are within a predetermined period of time.

84. The aerosol delivery device of any one of paragraphs 79 to 83, wherein the movement sensor includes at least one accelerometer.

85. The aerosol delivery device of any one of paragraphs 79 to 84, wherein the predetermined movement detected using the movement sensor includes a tap of the aerosol delivery device.

86. The aerosol delivery device of any one of paragraphs 79 to 85, wherein the predetermined movement of the movement sensor includes a sequence of taps of the aerosol delivery device.

87. The aerosol delivery device of any one of paragraphs 79 to 86, wherein the smoking substitute is configured to provide a first feedback indication to the user when both the predetermined movement is detected and a component is coupled to the device body.

88. The aerosol delivery device of any one of paragraphs 79 to 87, wherein the aerosol delivery device is configured to provide a second feedback indication to the user when a communication link is established between the aerosol delivery device and the mobile device.

89. The aerosol delivery device of paragraph 88, wherein the first and/or second feedback indication is a visual indication.

90. The aerosol delivery device of any one of paragraphs 79 to 89, further comprising a component configured to be coupled to the device body, wherein the component is a consumable component housing an aerosol precursor.

91. A system for managing an aerosol delivery device, the system including:
an aerosol delivery device according to any one of paragraphs 79 to 90; and
a mobile device,
wherein, upon receipt of the advertising communication from the aerosol delivery device, the application is configured to establish a communication link with the aerosol delivery device.

92. A method of managing an aerosol delivery device, the method comprising the steps of:
detecting that a component is coupled to a device body of the aerosol delivery device;
detecting a predetermined movement of the aerosol delivery device; and then sending an advertising communication to a mobile device.

93. A method of using the aerosol delivery device according to paragraph 90, the method comprising:
engaging the component with the device; and
performing a tap sequence on the aerosol delivery device, so as to instruct the aerosol delivery device to pair with a mobile device.

94. An aerosol delivery device including: a movement sensor; a controller; and a visual feedback element, wherein: the movement sensor is configured to detect rotary motion of the device about an axis, and to transmit a movement detection signal to the controller; and in response to receiving the movement detection signal, the controller is configured to cause the visual feedback element to display a visual output.

95. An aerosol delivery device according to paragraph 94, wherein a device body of the device is curved in a longitudinal direction such that a front surface of the device is convex with respect to a longitudinal axis of the device.

96. An aerosol delivery device according to paragraph 95, wherein the front surface is also convex with respect to transverse axis of the device.

97. An aerosol delivery device according to any one of paragraphs 94 to 96, wherein the movement sensor is configured to detect rotary motion about a third axis which is perpendicular to a transverse axis and a longitudinal axis of the device.

98. An aerosol delivery device according to paragraph 97, wherein movement sensor is configured to detect rotary motion about a central axis which is perpendicular to a transverse axis and a longitudinal axis of the device, and is located approximately hallway along the device in both the longitudinal and transverse directions.

99. An aerosol delivery device according to any one of paragraphs 94 to 98, wherein the movement sensor is configured to measure, detect, or determine a property of the rotary motion, and the movement detection signal includes movement data indicating the property of the rotary motion.

100. An aerosol delivery device according to paragraph 99, wherein the controller is configured to compare a value representing a property of the rotary motion with a predetermined threshold value, and only if it is determined that the value representing a property of the rotary motion exceeds the predetermined threshold, the controller may then cause the feedback means to output feedback.

101. An aerosol delivery device according to paragraph 100, wherein the predetermined threshold is determined based on an angular velocity or rate of rotation required to cause movement of liquid in a consumable component engageable with the aerosol delivery device, by centripetal or centrifugal force.

102. An aerosol delivery device according to any one of paragraphs 94 to 101, wherein: if the property of the rotary motion is represented by any of a first range of values, the controller is configured to cause the feedback means to output a first type of feedback, and if the property of the rotary motion is represented by any of a second range of values, the controller is configured to cause the visual feedback element to output a second type of feedback.

103. An aerosol delivery device according to paragraph 102, wherein the feedback means is a visual feedback element configured to display a visual output, wherein the visual feedback element includes a light source, and wherein the visual output includes illumination of the light source.

104. An aerosol delivery device according to paragraph 103, wherein the visual output includes flashing lights or moving lights, and wherein a frequency with which the lights flash, or a speed with which the lights move varies depending on a value representing a property of the rotary motion.

105. An aerosol-delivery system comprising a device according to any one of paragraphs 94 to 104, and a component for containing an aerosol precursor.

106. A method of using the aerosol-delivery system of paragraph 105, the method comprising engaging the consumable component with an aerosol-delivery device having a power source so as to electrically connect the power source to the component.

107. A method of causing liquid to move around a consumable component of an aerosol-delivery system, the method including spinning the aerosol-delivery system on a surface to cause movement of the fluid by centripetal or centrifugal force.

108. A method according to paragraph 107, wherein the aerosol delivery system is the aerosol-delivery system of paragraph 105, in which the component is engaged with the aerosol delivery device.

1. An aerosol delivery device comprising a main body, the main body having a control unit and a movement sensor configured to sense movement of the aerosol delivery device;
wherein the control unit is configured to send an advertising communication to a mobile device when:
a component is coupled to the main body; and
a predetermined movement of the aerosol delivery device is detected using the movement sensor.

2. The aerosol delivery device of claim 1, wherein the control unit is configured to send the advertising communication to the mobile device only when:
a component is coupled to the main body; and
the predetermined movement of the aerosol delivery device is detected using the movement sensor.

3. The aerosol delivery device of claim 1, wherein the control unit is configured to send the advertising communication to the mobile device when a change in state of the aerosol delivery device is detected, the change in state being from a disassembled state in which a component is not coupled to the main body, to an assembled state in which a component is coupled to the main body.

4. The aerosol delivery device of claim 3, wherein the control unit is configured to send the advertising communication to the mobile device when the change in state of the aerosol delivery device is detected before the predetermined movement of the aerosol delivery device is detected.

5. The aerosol delivery device of claim 3, wherein the control unit is configured to send the advertising communication to the mobile device when the detection of the change in state of the aerosol delivery device and the detection of the predetermined movement of the aerosol delivery device are within a predetermined period of time.

6. The aerosol delivery device of claim 1, wherein the movement sensor includes at least one accelerometer.

7. The aerosol delivery device claim 1, wherein the predetermined movement detected using the movement sensor includes a tap of the aerosol delivery device.

8. The aerosol delivery device of claim 1, wherein the predetermined movement of the movement sensor includes a sequence of taps of the aerosol delivery device.

9. The aerosol delivery device of claim 1, wherein the smoking substitute is configured to provide a first feedback indication to the user when both the predetermined movement is detected and a component is coupled to the main body.

10. The aerosol delivery device of claim 1, wherein the aerosol delivery device is configured to provide a second feedback indication to the user when a communication link is established between the aerosol delivery device and the mobile device.

11. The aerosol delivery device of claim 10, wherein the first and/or second feedback indication is a visual indication.

12. The aerosol delivery device of claim 1, further comprising a component configured to be coupled to the main body, wherein the component is a consumable component housing an aerosol precursor.

13. A system for managing an aerosol delivery device, the system including:
an aerosol delivery device according to claim 1; and
a mobile device,
wherein, upon receipt of the advertising communication from the aerosol delivery device, the application is configured to establish a communication link with the aerosol delivery device.

14. A method of managing an aerosol delivery device, the method comprising the steps of:
detecting that a component is coupled to a main body of the aerosol delivery device;
detecting a predetermined movement of the aerosol delivery device; and then
sending an advertising communication to a mobile device.

15. A method of using the aerosol delivery device according to claim 12, the method comprising:
engaging the component with the main body; and
performing a tap sequence on the aerosol delivery device, so as to instruct the aerosol delivery device to pair with a mobile device.

16. The aerosol delivery device of claim 2, wherein the control unit is configured to send the advertising communication to the mobile device when a change in state of the aerosol delivery device is detected, the change in state being from a disassembled state in which a component is not coupled to the main body, to an assembled state in which a component is coupled to the main body.

17. The aerosol delivery device of claim 16, wherein the control unit is configured to send the advertising communication to the mobile device when the change in state of the aerosol delivery device is detected before the predetermined movement of the aerosol delivery device is detected.

18. The aerosol delivery device of claim 16, wherein the control unit is configured to send the advertising communication to the mobile device when the detection of the change in state of the aerosol delivery device and the detection of the predetermined movement of the aerosol delivery device are within a predetermined period of time.

19. The aerosol delivery device of claim 4, wherein the control unit is configured to send the advertising communication to the mobile device when the detection of the change in state of the aerosol delivery device and the detection of the predetermined movement of the aerosol delivery device are within a predetermined period of time.

20. The aerosol delivery device of claim 17, wherein the control unit is configured to send the advertising communication to the mobile device when the detection of the change in state of the aerosol delivery device and the detection of the predetermined movement of the aerosol delivery device are within a predetermined period of time.
